(19) United States
(12) Patent Application Publication
(10) Pub. No.: US 2012/0189359 A1
(43) Pub. Date: Jul. 26, 2012

(54) PRINTING APPARATUS AND PRINTING METHOD

(76) Inventors: Koichi Kitakami, Chigasaki-shi (JP); Motokazu Kobayashi, Yokohama-shi (JP); Yoshimasa Araki, Yokohama-shi (JP)

(21) Appl. No.: 13/384,692

(22) PCT Filed: Aug. 20, 2010
(86) PCT No.: PCT/JP2010/064541

§ 371 Date: Jan. 18, 2012

(30) Foreign Application Priority Data
Aug. 24, 2009 (JP) 2009 192706
Nov. 26, 2009 (JP) 2009 269187

(51) Int. Cl. G03G 15/14

(52) U.S. Cl. 399/308

(57) ABSTRACT

A printing apparatus employs a photosensitive drum for forming a latent image on a surface region thereof, a developing unit for forming a protrusion by selectively causing ink repellent particles to adhere onto the surface region carrying the latent image formed thereon, an ink roller for feeding ink to the protrusion on the surface of the photosensitive drum, a blanket cylinder for receiving the ink from the projected region, an impression cylinder for pressing the ink on the surface of the blanket cylinder when the ink is transferred onto a sheet of paper, and a conveying unit for conveying the sheet of paper. The surface of the ink repellent particles has a property of repelling the ink, while the surface of the photosensitive drum has a property of not repelling the ink.

### TECHNICAL FIELD

This invention relates to an apparatus and a method for ondemand offset printing.

### BACKGROUND ART

Various so-called electrophotography type printers including laser beam printers and LED (light emitting diode) printers have been proposed to date and also have become popular in ondemand printing applications. On the other hand, flat plate offset printing systems have long been and are being employed for mass printing applications of printing more than 1,000 copies at a time.

While the printing quality of electrophotography type printers has been improved remarkably in recent years, a solid image printed on a whole sheet of paper by such a printer shows a poor color uniformity (with large color differences) and can give rise to a problem of a curled sheet. Additionally, printing on thin paper such as newspaper has not been realized by electrophotography type printers.

On the other hand, flat plate offset printing has become the main stream of newspaper printing and can print in color on the opposite surfaces of thin paper at high speed. The height of ink on a printed matter produced by flat plate offset printing is as low as about 2 μm. Flat plate offset printing is therefore characterized advantageously by being able to produce a printed matter without adversely affecting the texture of paper.

However, flat plate offset printing requires time and cost for plate making. Therefore, when a small number of printed sheets are output, it costs high. Hence, flat plate offset printing is not popular except in mass printing applications.

Thus, there has been a large demand for novel printing apparatus having an advantage of convenience comparable to electrophotography type printers and that of being able to provide a high printing quality of flat plate offset type printers on an ondemand basis without cost and time even when only a small number of printed sheets are output.

For example, PTL 1 proposes a method of forming a surface of a latent image forming drum with titanium oxide that is hydrophobic, forming a hydrophilic portion on the surface by irradiating ultraviolet rays according to the electronic data of an original, making the hydrophilic portion hold “dampening water”, then executing an offset printing operation by causing ink to adhere to the hydrophobic portion. In order to make the hydrophilic portion restore hydrophobicity, the surface is subsequently heated to a predetermined temperature. The above-cited PTL 1 states that ondemand printing can be realized by means of the above-described method.

On the other hand, PTL 2 proposes an ondemand letterpress printing method that does not employ any “dampening water”. The method includes steps of forming a toner image on the ink repellent surface of a plate cylinder by electrophotography, temporarily fixing it by heat, then applying ultraviolet setting type waterless offset ink onto the toner image, irradiating ultraviolet rays onto the ink image to set the ink and produce a temporary “plate” that is firmer than a plate carrying only a toner image, applying waterless ink for flat plate printing to the plate and transferring the ink onto a printing medium (such as a sheet of paper). An image can be printed on the printing medium on an ondemand basis by repeating the step of applying ink and transferring it and subsequently removing the toner image temporarily fixed on the object having an ink repellent surface with the ink image left on the toner image.

### CITATION LIST

### Patent Literature

PTL 1: Japanese Patent Application Laid-Open No. H10-250027

PTL 2: Japanese Patent Application Laid-Open No. H11-291603

### SUMMARY OF INVENTION

### Technical Problem

However, with the method disclosed in the above-cited PTL 1, dampening water and ink are fed and made to adhere to the hydrophilic portion and the hydrophobic portion produced on the surface of a plate that does not have any stepped part unlike an offset plate having stepped parts. Therefore, the edges of the liquid ink (boundaries of letters and images) on the surface are only confined by dampening water that is also liquid. Then, as a result, the edges of the ink are apt to move improperly when the ink is transferred onto a blanket cylinder whereby the boundaries of letters and image are shifted from the desired proper positions so that it is difficult to make the printed matter show a high printing quality.

With the method disclosed in the above-cited PTL 2, on the other hand, ink is applied to the protrusion produced by a temporarily fixed toner image (layer) and a layer formed by applying ink thereon and setting the ink by ultraviolet rays and the ink is transferred on a printing medium such as a sheet of paper. Therefore, the ink to be transferred onto a sheet of paper is laid on the protrusion without being confined at the peripheral sides thereof whereby the edges of the ink are apt to move improperly when the ink is transferred. Then, as a result, the boundaries of letters and images can be shifted from the proper positions so that it is difficult to make the printed matter show a high printing quality.

Additionally, the development process has three steps including (1) a temporarily fixing step, using toner, (2) a step of applying ink, which is to be set to form a foundation coat and (3) a step of applying ink that is to be ultimately transferred onto a sheet of paper to make the printing efficiency rather poor and provide a room for improvement from the viewpoint of raising the printing speed.

In view of the above-described circumstances, it is therefore the object of the present invention to provide a printing apparatus and a printing method that can prepare a “plate” at high speed on an ondemand basis and produce high quality edges of ink (boundaries of letters and images) as easily and conveniently as electrophotography type printers.

### Solution to Problem

According to the present invention, the above object is achieved in an aspect thereof by providing a printing apparatus employing a rewritable plate and including: a plate forming body for forming a rewritable plate; a latent image forming unit for forming a latent image on a region of a surface of the plate forming body; a protrusion forming unit for forming a protrusion by causing ink repellent particles to selectively adhere to the region of the surface of the plate forming body carrying the latent image formed thereon; an ink feeding unit for feeding ink to the surface of the plate forming body;

an intermediate transfer member for receiving the ink transferred from the surface of the plate forming body; a pressing unit for pressing the ink on the surface of the intermediate transfer member when the ink is transferred onto a recording medium; and

a conveying unit for conveying the recording medium, the surface of the ink repellent particles having a property of repelling the ink,

the surface of the plate forming body having a property of not repelling the ink.

In another aspect of the present invention, there is provided a printing method employing a rewritable plate and including:

a first step of forming a latent image on a surface of a plate forming body for forming a rewritable plate;

a second step of forming a protrusion on the surface of the plate forming body by causing ink repellent particles to adhere thereto according to the latent image;

a third step of feeding ink to the surface of the plate forming body to form an image part thereon;

a fourth step of transferring the ink on the surface of the plate forming body onto a surface of an intermediate transfer member; and

a fifth step of transferring the ink on the surface of the intermediate transfer member onto a recording medium,

the surface of the ink repellent particles having a property of repelling the ink,

the surface of the plate forming body having a property of not repelling the ink.

### Advantageous Effects of Invention

Thus, according to the present invention, a non-image region where no ink adheres can be formed on the surface of a plate forming body because the ink repellent particles that form a protrusion repel ink. This is due to the fact that the surface of the plate forming body has a property of not repelling the ink. Then, an image region where ink adheres can be formed on the surface of the plate forming body except the protrusion formed by the water repellent ink. Then, as a result, the edges of the ink of the image region are reliably confined by particles that are solid. Thus, a printing apparatus and a printing method that can produce high quality edges (boundaries of letters and images) can be provided. Additionally, according to the present invention, no dampening water is required because ink repellent particles are employed, which can provide a printing method that is friendly to the environment.

Further features of the present invention will become apparent from the following description of exemplary embodiments with reference to the attached drawings.

### BRIEF DESCRIPTION OF DRAWINGS

FIG. 1A is a schematic illustration of the configuration of the first embodiment of the present invention. FIG. 1B is a schematic illustration of the ink transferring step of the first embodiment of the present invention.

FIGS. 2A, 2B, 2C and 2D are schematic illustrations of the printing step of the first embodiment of the present invention.

FIG. 3 is a schematic illustration of the configuration of the second embodiment of the present invention.

FIGS. 4A, 4B, 4C and 4D are schematic illustrations of the printing step of the second embodiment of the present invention.

FIG. 5 is a schematic illustration of the configuration of the fourth embodiment of the present invention.

FIGS. 6A, 6B, 6C and 6D are schematic illustrations of the printing step of the fourth embodiment of the present invention.

FIG. 7 is a schematic illustration of the configuration of the fifth embodiment of the present invention.

FIGS. 8A, 8B, 8C and 8D are schematic illustrations of the printing step of the fifth embodiment of the present invention.

FIG. 9 is a schematic illustration of the configuration of the sixth embodiment of the present invention.

FIGS. 10A, 10B, 10C and 10D are schematic illustrations of the printing step of the sixth embodiment of the present invention.

FIG. 11 is a schematic illustration of the configuration of the eighth embodiment of the present invention.

FIGS. 12A, 12B, 12C, 12D and 12E are schematic illustrations of the printing step of the eighth embodiment of the present invention.

FIG. 13 is a schematic illustration of the configuration of the ninth embodiment of the present invention.

FIGS. 14A, 14B, 14C, 14D, 14E and 14F are schematic illustrations of the printing step of the ninth embodiment of the present invention.

### DESCRIPTION OF EMBODIMENTS

Now, preferred embodiments of the present invention will be described below by referring to the accompanying drawings.

### EXAMPLE 1

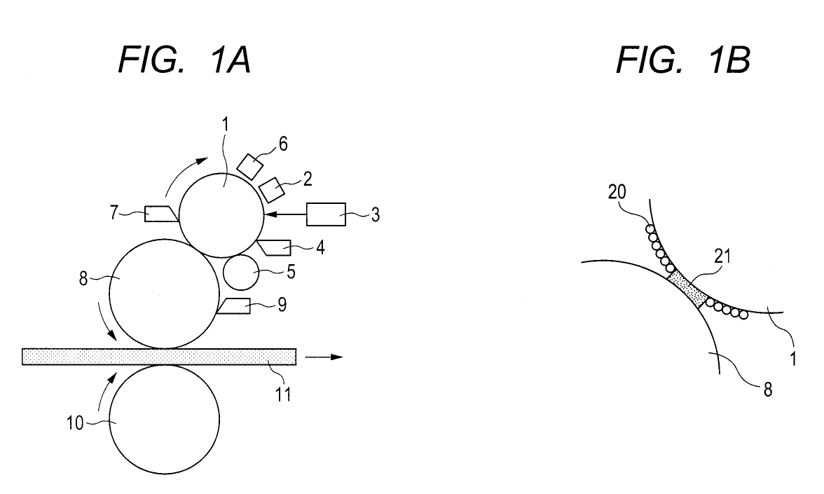

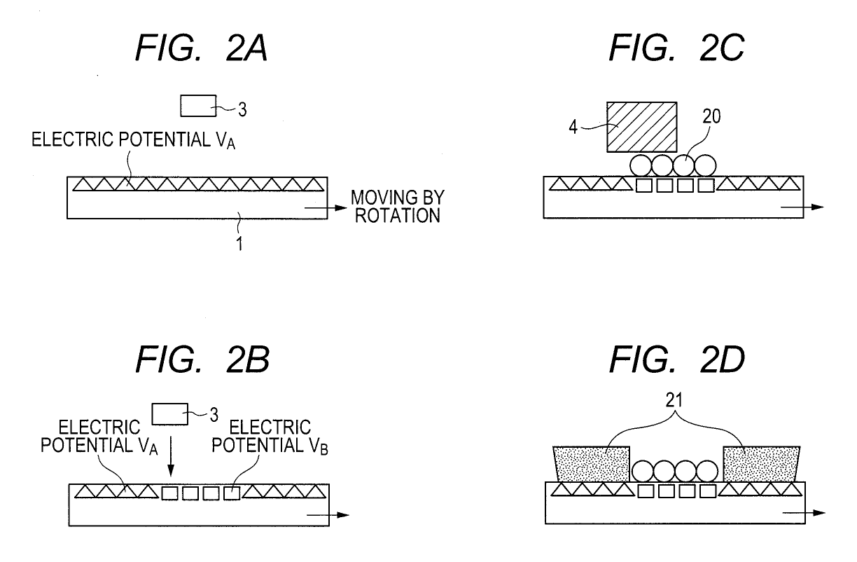

The first embodiment of the present invention will now be described by referring to FIGS. 1A, 1B and 2A through 2D. As illustrated in FIG. 1A, the printing apparatus of this embodiment includes a photosensitive drum 1 that is a plate forming body for forming a rewritable plate and made of an amorphous silicon (a-Si) photosensitive body. A charger 2, an exposure unit 3, a developing unit 4, an ink roller 5, a charge eliminator 6 and a first cleaner 7 are arranged around the photosensitive drum 1. The exposure unit 3 is a latent image forming unit for drawing a latent image on the surface of the photosensitive drum 1 that operates as plate forming body. The developing unit 4 is a protrusion forming unit for forming a protrusion by selectively causing ink repellent particles 20 to adhere to the region where a latent image is formed on the surface of the photosensitive drum 1 that operates as plate forming body. The ink roller 5 is an ink feeding unit for feeding ink 21 onto the surface of the photosensitive drum 1 that operates as plate forming body. Additionally, a blanket cylinder 8 is arranged as intermediate transfer member for transferring the ink 21 supplied onto the surface of the photosensitive drum 1 that operates as plate forming body. Furthermore, a second cleaner 9 and an impression cylinder 10 that operates as pressing unit for pressing the ink 21 on the surface of the blanket cylinder 8 when the ink 21 is transferred onto a sheet of paper 11 that is a recording medium are arranged around the blanket cylinder 8. The blanket cylinder 8 and the impression cylinder 10 also operate as conveying unit for conveying the sheet of paper 11 that operates as recording medium.

The photosensitive drum 1, the ink roller 5, the blanket cylinder 8 and the impression cylinder 10 are driven to rotate in the sense of arrow in FIG. 1A by a motor (not illustrated) according to the digital signal transmitted from a host computer (not illustrated). Additionally, the sheet of paper 11 that operates as recording medium is conveyed to between the blanket cylinder 8 and the impression cylinder 10 by a conveying unit (not illustrated) in response to the above operation.

Commercially available oil-based ink (sheetfed offset printing ink Diatone Ecopure SOY-HPJ available from Sakata Inx) is employed in this Embodiment 1 along with an amorphous silicon type photosensitive drum 1 that can reliably accommodate ink that contains solvent. The surface (surface protecting layer) of the amorphous silicon photosensitive drum 1 is formed by an amorphous material that is based on at least either silicon or carbon and hence it is ink-philic (oil-philic). The surface protecting layer can be formed by means of a high-frequency plasma CVD (chemical vapor deposition) method or a PCVD (plasma chemical vapor deposition) method.

The surface of the photosensitive drum 1 is electrically charged to −600 V (electric potential V_{A} in FIG. 2A) by means of the charger 2 and subsequently an electrostatic latent image is drawn and formed at the position that corresponds to the non-image part (electric potential V_{B} in FIG. 2B) by means of the exposure unit 3. The electric potential V_{B} is about −30 V in this embodiment.

Thereafter, ink repellent particles 20 are made to adhere to the non-image part (the −30 V site) by reversal development, while the developing unit 4 storing ink repellent particles 20 that are electrically negatively charged by friction is held to −400 V (electric potential V_{C}) (See FIG. 2C). The principle of adhesion of ink repellent particles 20 is based on “the relationship between an electric field vector and a force vector”. Thus, an electric field vector that is directed to the developing unit 4 from the exposure surface is formed between the developing unit 4 of −400 V and the exposure surface of −30 V. Therefore, at the same time, a force vector operates to attract the ink repelling particles 20 located between the developing unit 4 and the non-image part (the −30 V site) to the non-image part (−30 V site). On the other hand, an electric field vector that is directed from the developing unit 4 to the surface of −600 V is formed between the surface of −600 V that is not exposed and the developing unit 4 of −400 V. At the same time, the force vector operates to drive the ink repellent particles 20 away. This is the idea that is generally employed in the developing step of an electrophotography type printing process.

Ink repellent particles 20 are made to adhere by means of a so-called contact developing method. It is sufficient for the adherent force of ink repellent particles 20 to be adjusted under desired conditions by controlling the differences of the electric potentials of V_{A}, V_{B} and V_{C}, maintaining the relationship of formula (1) shown below for the magnitude relationship of the absolute values of V_{A}, V_{B} and V_{C} when they are all negative electric potentials.

(absolute value of electric potential V_{A})>(absolute value of electric potential V_{C})>(absolute value of electric potential V_{B}) (1)

Resin made of hydrophilic polymer molecules such as polyvinyl alcohol, polyvinyl pyrrolidone, polyacrylic acid, nylon or cellulose may be applied to ink repellent particles 20 when oil-based ink 21 is employed. Alternatively, hydrophobic oil repellent resin made of fluorine or silicon may be applied to ink repellent particles 20. Still alternatively, commercially available particles may be applied to ink repellent particles 20. Such particles include, for example, polytetrafluoroethylene particles (Lubron (registered trademark) L-5F) available from Daikin Industries, powder of polytetrafluoroethylene (Teflon (registered trademark) 7A) available from Du Pont Mitsui Fluorochemicals, PFA particles (MP 10) available from Du Pont Mitsui Fluorochemicals, FEP particles (5328000) available from Du Pont and silicon powder (Torefil (registered trademark) E-606) available from DOW CORNIONG TORAY. Ink repellent particles 20 may be prepared in a manner as described below. Namely, (1) They may be prepared by melting/kneading desired resin, crushing it and subsequently dispersing it in liquid or spraying it in gas to turn it into particles or (2) They may be prepared by polymerizing monomers that corresponds to desired resin and at the same time turning it into particles. One or more than one oily ingredients, one or more than one magnetic substances and/or a charge control agent may be added internally and/or externally to ink repellent particles 20. Additives that may be mixed with ink repellent particles 20 include inorganic micro powder and inorganic micro powder and organic micro powder that are surface-treated. For this embodiment, powder of polytetrafluoroethylene (Teflon (registered trademark) 7A) available from Du Pont Mitsui Fluorochemicals is employed as ink repellent particles 20 after adding silica micro particles to it by 2 wt %.

In the case of offset printing, an excellent printing quality can be achieved when the height of the ink 21 that is to be ultimately transferred onto a sheet of paper 11 is between 2 μm and 3 μm. Additionally, since the height of the ink 21 fed to the surface of the photosensitive drum 1 that operates as plate forming body is required to be greater than 2 μm to 3 μm, the weight average particle size of ink repellent particles 20 is preferably not smaller than 5 μm and not greater than 170 μm, more preferably not smaller than 5 μm and not greater than 30 μm, most preferably not smaller than 5 μm and not greater than 10 μm.

For the above-described exposure unit 3, one designed to scan the laser beam from a semiconductor laser oscillator by rotating a polygon mirror and forming an electrostatic latent image on the photosensitive drum 1 is employed. However, one having a light source prepared by arranging LEDs (light emitting diodes) may alternatively be employed as the exposure unit 3.

Then, ink 21 is fed onto the photosensitive drum 1 by means of the ink roller 5. At this time, the ink roller 5 and the photosensitive drum 1 are desirably driven to rotate in a state where they substantially show no velocity difference in the circumferential direction at the contact position of them.

As the ink roller 5 and the photosensitive drum 1 are driven to rotate, there arises a state where the layer of the ink 21 adhering to the peripheral surface of the ink roller 5 is pressed against the photosensitive drum 1 where ink repellent particles 20 adhere. Thus, force trying to eliminate each other takes place between the surface of the layer of the ink 21 on the surface of the ink roller 5 being pressed against the photosensitive drum 1 and the ink repellent particles 20 due to the ink-repellent property (the property of repelling ink). Therefore, the surface of the layer of the ink 21 and the ink repellent particles 20 are separated from each other due to the property of repelling ink (the ink-repellent property) in the process where the ink roller 5 and the photosensitive drum 1 are driven to rotate further to increase the gap between them in a radial direction.

On the other hand, the surface of the photosensitive drum 1 that is ink-philic is wetted by ink 21 and adsorbs the ink 21 (at the region where no ink repellent particles 20 are adhering). Thus, part of the thickness of the layer of the ink 21 adhering to the peripheral surface of the ink roller 5 is peeled off and the surface of the photosensitive drum 1 holds ink 21 in the process where the ink roller 5 and the photosensitive drum 1 are driven to rotate further to increase the gap between them in a radial direction (see FIG. 2D). This process is same as the corresponding process of offset printing.

Namely, in this embodiment, the surfaces of the ink repellent particles 20 adhering to the part of the surface where a latent image is formed by the developing unit 4 operating as protrusion forming unit for the photosensitive drum 1 that operates as plate forming body show a property of repelling the ink 21. On the other hand, the surface of the photosensitive drum 1 shows a property of not repelling ink 21. Particularly, oil-based ink 21 is employed and the surfaces of the ink repellent particles 20 are oil repellent, whereas the surface of the photosensitive drum 1 is oil-philic in this embodiment.

The thickness of the ink 21 held to the surface of the photosensitive drum 1 is controlled by an adjustment method of adjusting “the gap between the ink roller 5 and the photosensitive drum 1” and “the thickness of the layer of the ink 21 on the surface of the ink roller 5” that is being generally employed for offset printing. Additionally, while the ink repellent particles 20 is drawn as forming a single layer in FIGS. 2C and 2D for the sake of convenience, they may alternatively be arranged to form a plurality of layers so long as they provide a sufficient adherent force.

Thereafter, the ink 21 held to the surface of the photosensitive drum 1 due to the wetted state of the photosensitive drum 1 and the ink repellent particles 20 held to the photosensitive drum 1 by electromagnetic image force move to the contact position of the drum 1 and the blanket cylinder 8. An ink-philic rubber material similar to the one that is generally employed for offset printing is wound around the surface of the blanket cylinder 8. The blanket cylinder 8 has a structure produced by winding an ink-philic rubber material around part of a cylinder that is formed by a metal material like blanket cylinders of ordinary offset printing.

Additionally, the surface and its vicinity of the blanket cylinder 8 is held to −100 V. As a result, a force vector is produced in the ink repellent particles 20 in a direction of moving them away from the surface of the blanket cylinder 8 according to “the relationship between an electric field vector and a force vector” and hence they would not be transferred onto the surface of the blanket cylinder 8.

Thus, only part of the thickness of the layer of the ink 21 fed onto the photosensitive drum 1 is intermediately transferred onto the blanket cylinder 8 that is arranged with a desired gap between them (see FIG. 1B). The quantity by which ink is transferred (the thickness of the layer of the ink 21) is controlled by an adjustment method of adjusting the “gap between the photosensitive drum 1 and the blanket cylinder 8” and so on that is being generally employed for offset printing. Of course, it also is related to adjustment of the thickness of the ink 21 held to the surface of the photosensitive drum 1 and hence “the gap between the ink roller 5 and the photosensitive drum 1” and “the thickness of the layer of the ink 21 on the surface of the ink roller 5” may also sometimes need to be adjusted.

Thereafter, the region on the photosensitive drum 1 where the intermediate transfer step has been completed moves to the position of the first cleaner 7. The first cleaner 7 is designed so as to collectively remove the ink repellent particles 20 and the ink 21 by way of a scraping off operation by means of a rubber blade and subsequently wash the region. If necessary, a drying unit may be arranged downstream relative to the site where the cleaning step by the first cleaner 7 is conducted. Thereafter, the region on the photosensitive drum 1 is moved to the position of the charge eliminator 6 to eliminate the electric charge.

The image formed by the ink 21 that is intermediately transferred onto the blanket cylinder 8 is then transferred onto the sheet of paper 11 that is a recording medium pinched between the blanket cylinder 8 and the impression cylinder 10 to complete the printing. The region on the blanket cylinder 8 where the step of transferring the image onto the sheet of paper 11 has been completed is cleaned by the second cleaner 9 so as to remove the residual ink and restore the initial state. Then, ondemand digital offset printing is realized after completing an operation by the charger 2 and a step of proceeding to the exposure unit 3 for another time.

While single color printing using black ink is described above for the sake of convenience, full color printing can be realized by providing the arrangement of FIG. 1A also for inks 21 of cyan, magenta and yellow.

Thus, the printing method of this embodiment is a printing method of employing a rewritable plate. The method includes a first step of drawing a latent image on the surface of the photosensitive drum 1 that operates as plate forming body for forming a rewritable plate and a second step of causing ink repellent particles 20 to adhere to the surface of the photosensitive drum 1 according to the latent image to form a protrusion. The method further includes a third step of feeding ink 21 on the surface of the photosensitive drum 1 to form an image part and a fourth step of transferring the ink 21 on the surface of the photosensitive drum 1 onto the blanket cylinder 8 that operates as intermediate transfer member. The method additionally includes a fifth step of transferring the ink 21 on the surface of the blanket cylinder 8 onto a sheet of paper 11 that is a recording medium. Furthermore, the surfaces of the ink repellent particles 20 are made to have a property of repelling ink 21 whereas the surface of the photosensitive drum 1 is made to have a property of not repelling ink 21.

When same printed matters are to be output, high-speed printing can be realized by skipping the operations of the first cleaner 7, the charge eliminator 6, the charger 2, the exposure unit 3 and the developing unit 4 after executing a developing operation by means of the ink repellent particles 20.

### EXAMPLE 2

The above-described first embodiment adopts an electrostatic method for the latent image forming principle and is made to include a photosensitive drum 1 that operates as plate forming body, an exposure unit 3 that operates as latent image forming unit, a developing unit 4 for causing ink repellent particles 20 to adhere as protrusion forming unit, a charger 2 and a charge eliminator 6. On the other hand, this embodiment adopts a magnetic method for the latent image forming principle and is made to include a magnetic drum 31 that operates as plate forming body, a magnetic head 32 that operates as latent image forming unit, a developing unit 34 for causing ink repellent magnetic particles 50 to adhere as protrusion forming unit and a demagnetizer 36 as an example.

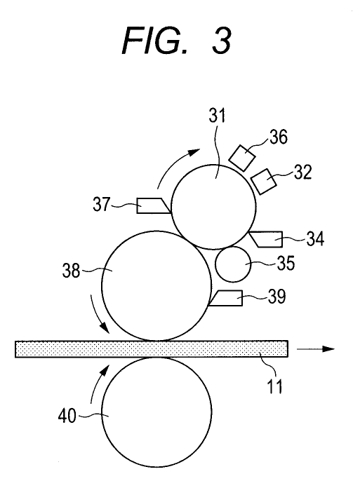

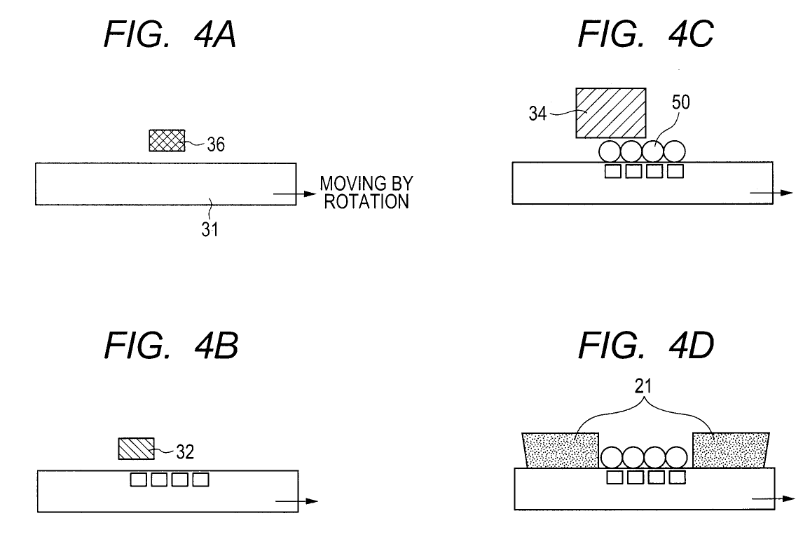

Now, this embodiment will be described below by referring to FIGS. 3 and 4A through 4D. As shown in FIG. 3, the printing apparatus of this embodiment has a magnetic drum 31 as plate forming body and a demagnetizer 36, a magnetic head 32 that operates as latent image forming unit, a developing unit 34 that operates as protrusion forming unit, an ink roller 35 that operates as ink feeding unit and a first cleaner 37 are arranged around the magnetic drum 31. Additionally, a second cleaner 39 and an impression cylinder 40 that operates as pressing unit are arranged around the blanket cylinder 38 that operates as intermediate transfer member.

The magnetic drum 31, the ink roller 35, the blanket cylinder 38 and the impression cylinder 40 are driven to rotate in the sense of arrow in FIG. 3 by a motor (not illustrated) according to the digital signal transmitted from a host computer (not illustrated). Additionally, the sheet of paper 11 that operates as recording medium is conveyed by a conveying unit (not shown) in response to the above operation.

Commercially available oil-based ink (sheetfed offset printing ink Diatone Ecopure SOY-HPJ available from Sakata Inx) 21 is employed also in this embodiment and the magnetic drum 31 is overcoated with polystyrene, although any appropriate ink-philic material other than polystyrene such as polyethylene, polypropylene, polymethylmethacrylate, polyethylene terephthalate, polyimide may alternatively be selected and employed as overcoat. The underlayer thereof is undercoated by a magnetic material such as ferrite.

A demagnetizing process is executed on the magnetic drum 31 by the demagnetizer 36 as shown in FIG. 4A and subsequently the surface of the magnetic drum 31 is magnetized by the magnetic head 32 in the region that corresponds to a non-image part to form a magnetic latent image as shown in FIG. 4B. Thereafter, ink repellent magnetic particles 50 stored in the developing unit 34 are made to adhere to the magnetic latent image by means of magnetic force as shown in FIG. 4C.

The above-described ink repellent magnetic particles 50 are preferably a ferromagnetic substance such as ferrite, manganese-zinc ferrite, manganese-nickel ferrite, magnetite, nickel or permalloy. Preferably, the ink repellent magnetic particles 50 show a high magnetic permeability and the surfaces thereof are treated for ink repellency by means of fluorine or silicon.

In the case of offset printing, an excellent printing quality can be achieved when the height of the ink 21 that is to be ultimately transferred onto a sheet of paper 11 is between 2 μm and 3 μm. Additionally, since the height of the ink 21 fed to the surface of the magnetic drum 31 that operates as plate forming body is required to be greater than 2 μm to 3 μm, the weight average particle size of ink repellent magnetic particles 50 is preferably not smaller than 5 μm and not greater than 170 μm, more preferably not smaller than 5 μm and not greater than 30 μm, most preferably not smaller than 5 μm and not greater than 10 μm.

Then, ink 21 is fed onto the magnetic drum 31 by means of the ink roller 35. At this time, the ink roller 35 and the magnetic drum 31 are desirably driven to rotate in a state where they substantially show no velocity difference in the circumferential direction at the contact position of them.

As the ink roller 35 and the magnetic drum 31 are driven to rotate, there arises a state where the layer of the ink 21 adhering to the peripheral surface of the ink roller 35 is pressed against the magnetic drum 31 where ink repellent magnetic particles 50 adhere. Thus, force trying to eliminate each other takes place between the surface of the layer of the ink 21 on the surface of the ink roller 35 being pressed against the magnetic drum 31 and the ink repellent magnetic particles 50 due to the ink-repellent property (the property of repelling ink). Therefore, the surface of the layer of the ink 21 and the ink repellent magnetic particles 50 are separated from each other due to the repelling property (the ink-repellent property) in the process where the ink roller 35 and the magnetic drum 31 are driven to rotate further to increase the gap between them in a radial direction.

On the other hand, the surface of the magnetic drum 31 that is ink-philic is wetted by ink 21 and adsorbs the ink 21 (at the region where no ink repellent magnetic particles 50 are adhering). Thus, part of the thickness of the layer of the ink 21 adhering to the peripheral surface of the ink roller 35 is peeled off and the surface of the magnetic drum 31 holds ink 21 in the process where the ink roller 35 and the magnetic drum 31 are driven to rotate further to increase the gap between them in a radial direction (see FIG. 4D). This process is same as the corresponding process of offset printing.

The thickness of the ink 21 held to the surface of the magnetic drum 31 is controlled by an adjustment method of adjusting “the gap between the ink roller 35 and the magnetic drum 31” and “the thickness of the layer of the ink 21 on the surface of the ink roller 35” that is being generally employed for offset printing. Additionally, while the ink repellent magnetic particles 50 are drawn as forming a single layer in FIGS. 4C and 4D for the sake of convenience, they may alternatively be arranged to form a plurality of layers so long as they provide a sufficient adherent force.

Thereafter, the ink 21 held to the surface of the magnetic drum 31 due to the wetted state of the magnetic drum 31 and the ink repellent magnetic particles 50 held by magnetic force move to the contact position of the drum 31 and the blanket cylinder 38. An ink-philic rubber material similar to the one that is generally employed for offset printing is wound around the surface of the blanket cylinder 38.

Additionally, since the ink repellent magnetic particles 50 are made to firmly adhere to the surface of the magnetic drum 31 by magnetic force, they would not be transferred onto the surface of the blanket cylinder 38. If necessary, means for generating magnetic force (a magnetic field) that tries to drive ink repellent magnetic particles 50 to move away may be incorporated into the inside of the blanket cylinder 38.

Thus, only part of the thickness of the layer of the ink 21 fed onto the magnetic drum 31 is intermediately transferred onto the blanket cylinder 38 that is arranged with a desired gap between them. The quantity (the thickness) by which ink is transferred is controlled by an adjustment method of adjusting the “gap between the magnetic drum 31 and the blanket cylinder 38” and so on that is being generally employed for offset printing. Of course, it also is related to adjustment of the thickness of the ink 21 held to the surface of the magnetic drum 31 and hence “the gap between the ink roller 35 and the magnetic drum 31” and “the thickness of the layer of the ink 21 on the surface of the ink roller 35” may also sometimes need to be adjusted.

Thereafter, the region on the magnetic drum 31 where the intermediate transfer step has been completed moves to the position of the first cleaner 37. The first cleaner 37 is designed so as to collectively remove the ink repellent magnetic particles 50 and the ink 21 by way of a scraping off operation by means of a rubber blade and subsequently wash the region. If necessary, a drying unit may be arranged downstream relative to the site where the cleaning step by the first cleaner 37 is conducted. Thereafter, the region on the magnetic drum 31 is moved to the position of the demagnetizer 36 for demagnetization.

The image formed by the ink 21 that is intermediately transferred onto the blanket cylinder 38 is then transferred onto the sheet of paper 11 that is a recording medium pinched between the blanket cylinder 38 and the impression cylinder 40 to complete the printing. The region on the blanket cylinder 38 where the step of transferring the image onto the sheet of paper 11 has been completed is cleaned by the second cleaner 39 so as to remove the residual ink and restore the initial state. Then, ondemand digital offset printing is realized after completing an operation by the demagnetizer 36 and a step of proceeding to the magnetic head 32 for another time.

While single color printing using black ink is described above for the sake of convenience, full color printing can be realized by providing the arrangement of FIGS. 3 and 4A through 4D also for inks of cyan, magenta and yellow. When same printed matters are to be output, high-speed printing can be realized by skipping the operations of the first cleaner 37, the demagnetizer 36, the magnetic head 32 and the developing unit 34 after executing a developing operation by means of the ink repellent magnetic particles 50.

An electrostatic method and a magnetic method are described as examples for the latent image forming principle underlying the operation of forming a protrusion on the surface of a plate forming body by selectively causing ink repellent particles 20 and 50 to adhere thereto in the above-described first and second embodiments. However, some other principle may alternatively be employed for the purpose of the present invention.

### EXAMPLE 3

In this embodiment, water-based ink is employed as ink and the surfaces of ink repellent magnetic particles 50 are made water repellent while the surface of the magnetic drum 31 that operates as plate forming body is made hydrophilic as an example.

Commercially available water-based ink (available from Fuji Ink Manufacturing Co., Ltd.: NSG-T Type) is employed in this embodiment as an example. Otherwise, the configuration and the principle of operation of this embodiment are same as those of the above-described second embodiment. Note, however, that the surface of the magnetic drum 31 that operates as plate forming body is coated with hydrophilic polyvinyl alcohol, although it may alternatively be coated with a hydrophilic polymer material other than polyvinyl alcohol that is selected from polyvinyl pyrrolidone, polyacrylic acid, cellulose, nylon and so on. Additionally, the coat surface may be made to be porous or have micro undulations to improve the hydrophilicity. The surfaces of ink repellent magnetic particles 50 are made water repellent and treated by fluorine or silicon so as turn them hydrophobic.

Full color printing can be realized by providing the arrangement of FIG. 3 also for water-based inks of black, cyan, magenta and yellow. When same printed matters are to be output, high-speed printing can be realized by skipping the operations of the first cleaner 37, the demagnetizer 36, the magnetic head 32 and the developing unit 34 after executing a developing operation by means of the ink repellent magnetic particles 50.

### EXAMPLE 4

In this embodiment, oil-based ink is employed as ink and the surfaces of ink repellent particles 20 are made oil repellent while the surface of an adhesive drum 31 that operates as plate forming body is made oil-philic as an example.

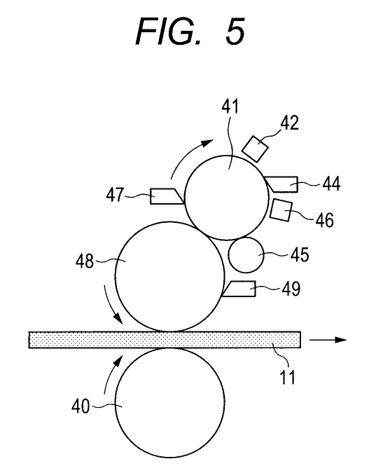

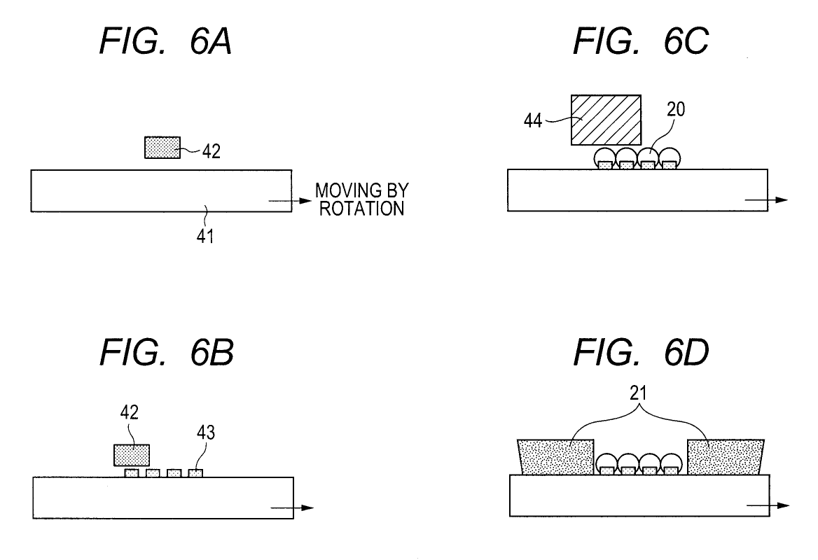

This embodiment will be described below by referring to FIGS. 5 and 6A through 6D. As shown in FIG. 5, the printing apparatus of this embodiment includes the adhesive drum 41 that operates as plate forming body and a dispenser 42 that operates as latent image forming unit, a developing unit 44 that operates as protrusion forming unit, a drier nozzle 46, an ink roller 45 that operates as ink feeding unit and a first cleaner 47 are arranged around the adhesive drum 41. Additionally, a second cleaner 49 and an impression cylinder 40 that operates as pressing unit are arranged around a blanket cylinder 48 that operates as intermediate transfer member.

The adhesive drum 41, the ink roller 45, the blanket cylinder 48 and the impression cylinder 40 are driven to rotate in the sense of arrow in FIG. 5 by a motor (not illustrated) according to the digital signal transmitted from a host computer (not illustrated). Additionally, the sheet of paper 11 that operates as recording medium is conveyed by a conveying unit (not shown) in response to the above operation.

Commercially available oil-based ink (sheetfed offset printing ink Diatone Ecopure SOY-HPJ available from Sakata Inx) 21 is employed also in this embodiment and the adhesive drum 41 is overcoated with polystyrene, although any appropriate ink-philic material other than polystyrene such as polyethylene, polypropylene, polymethylmethacrylate, polyethylene terephthalate, polyimide may alternatively be selected and employed as overcoat.

As shown in FIGS. 6A and 6B, a latent image is formed on the adhesive drum 41 by supplying silicon-based adhesive agent to the part of the surface of the adhesive drum 41 that corresponds to a non-image part by means of a dispenser (ACCURA 9 available from Iwashita Engineering, Inc.) on a dot by dot basis. The adhesive agent 43 that is supplied may alternatively be a resin-based adhesive such as epoxy-based, rubber-based or urethane-based. Then, ink repellent particles 20 stored in the developing unit 44 are made to adhere to the adhesive latent image by adhesive force as shown in FIG. 6C. No ink repellent particle 20 adheres to the part of the surface of the adhesive drum where no adhesive latent image is formed. Thereafter, the force holding the ink repellent particles 20 is improved by accelerating the process of drying and setting the adhesive agent 43 by means of the drier nozzle 46.

When oil-based ink 21 is employed, silica micro particles are added to powder of polytetrafluoroethylene (Teflon (registered trademark) 7A) available from Du Pont Mitsui Fluorochemicals by 2 wt % and the mixture is employed as ink repellent particles 20.

In the case of offset printing, an excellent printing quality can be achieved when the height of the ink 21 that is to be ultimately transferred onto a sheet of paper 11 is between 2 μm and 3 μm. Additionally, since the height of the ink 21 fed to the surface of the adhesive drum 41 that operates as plate forming body is required to be greater than 2 μm to 3 μm, the weight average particle size of ink repellent particles 20 is preferably not smaller than 5 μm and not greater than 170 μm, more preferably not smaller than 5 μm and not greater than 30 μm, most preferably not smaller than 5 μm and not greater than 10 μm.

Then, ink 21 is fed onto the adhesive drum 41 by means of the ink roller 45. At this time, the ink roller 45 and the adhesive drum 41 are desirably driven to rotate in a state where they substantially show no velocity difference in the circumferential direction at the contact position of them.

As the ink roller 45 and the adhesive drum 41 are driven to rotate, there arises a state where the layer of the ink 21 adhering to the peripheral surface of the ink roller 45 is pressed against the adhesive drum 41 where ink repellent particles 20 adhere. Thus, force trying to eliminate each other takes place between the surface of the layer of the ink 21 on the surface of the ink roller 45 being pressed against the adhesive drum 41 and the ink repellent particles 20 due to the ink-repellent property (the property of repelling ink 21). Therefore, the surface of the layer of the ink 21 and the ink repellent particles 20 are separated from each other due to the property of repelling ink (the ink-repellent property) in the process where the ink roller 45 and the adhesive drum 41 are driven to rotate further to increase the gap between them in a radial direction.

On the other hand, the surface of the adhesive drum 41 that is ink-philic is wetted by ink 21 and adsorbs the ink 21 (at the region where no ink repellent particles 20 are adhering). Thus, part of the thickness of the layer of the ink 21 adhering to the peripheral surface of the ink roller 45 is peeled off and the surface of the adhesive drum 41 holds ink 21 in the process where the ink roller 45 and the adhesive drum 41 are driven to rotate further to increase the gap between them in a radial direction (see FIG. 6D). This process is same as the corresponding process of offset printing.

The thickness of the ink 21 held to the surface of the adhesive drum 41 is controlled by an adjustment method of adjusting “the gap between the ink roller 45 and the adhesive drum 41” and “the thickness of the layer of the ink 21 on the surface of the ink roller 45” that is being generally employed for offset printing.

Thereafter, the ink 21 held to the surface of the adhesive drum 41 due to the wetted state of the adhesive drum 41 and the ink repellent particles 20 held in position by adhesive force move to the contact position of the drum 41 and the blanket cylinder 48. An ink-philic rubber material similar to the one that is generally employed for offset printing is wound around the surface of the blanket cylinder 48.

Additionally, the ink repellent particles 20 are made to firmly adhere to the surface of the adhesive drum 41 by adhesive force and hence they would not be transferred onto the surface of the blanket cylinder 48.

Thus, only part of the thickness of the layer of the ink 21 fed onto the adhesive drum 41 is intermediately transferred onto the blanket cylinder 48 that is arranged with a desired gap between them. The quantity by which ink is transferred (the thickness) is controlled by an adjustment method of adjusting the “gap between the adhesive drum 41 and the blanket cylinder 48” and so on that is being generally employed for offset printing. Of course, it also is related to adjustment of the thickness of the ink 21 held to the surface of the adhesive drum 41 and hence “the gap between the ink roller 45 and the adhesive drum 41” and “the thickness of the layer of the ink 21 on the surface of the ink roller 45” may also sometimes need to be adjusted.

Thereafter, the region on the adhesive drum 41 where the intermediate transfer step has been completed moves to the position of the first cleaner 47. The first cleaner 47 is designed so as to collectively remove the ink repellent particles 20, the adhesive agent 43 and the ink 21 by way of a scraping off operation by means of a rubber blade and subsequently wash the region. If necessary, a drying unit may be arranged downstream relative to the site where the cleaning step by the first cleaner 47 is conducted.

The image formed by the ink 21 that is intermediately transferred onto the blanket cylinder 48 is then transferred onto the sheet of paper 11 that is a recording medium pinched between the blanket cylinder 48 and the impression cylinder 40 to complete the printing. The region on the blanket cylinder 48 where the step of transferring the image onto the sheet of paper 11 has been completed is cleaned by the second cleaner 49 so as to remove the residual ink 21 and restore the initial state. Then, ondemand digital offset printing is realized after completing an operation by the dispenser 42 for another time.

While single color printing using black ink is described above for the sake of convenience, full color printing can be realized by providing the arrangement of FIG. 5 also for oil-based inks of black, cyan, magenta and yellow. When same printed matters are to be output, high-speed printing can be realized by skipping the operations of the first cleaner 47, the drier nozzle 46, the dispenser 42 and the developing unit 44 after executing a developing operation by means of the ink repellent particles 20.

If ink that cannot be classified either as “oil-based” or as “water-based” is involved in some technical fields in certain instances, the ink repellent particles 20 and 50 should have a property of repelling the ink, whereas the surface of the plate forming body such as the photosensitive drum 1, the magnetic drum 31 and the adhesive drum 41 should have a property of not repelling the ink. Then, embodiments that exploit these properties are included in the present invention.

### EXAMPLE 5

In this embodiment, the ink repellent particles on photosensitive drum 1 that is formed by an amorphous silicon (a-Si) photosensitive body to operate as plate forming body are heated to melt and thermo-compression-bonded onto the photosensitive drum 1 as an example. Otherwise, the configuration of this embodiment is same as that of Embodiment 1.

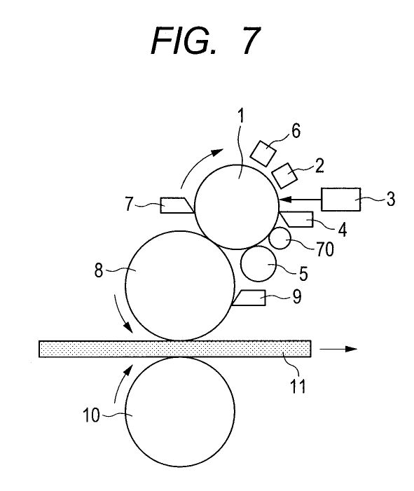

As illustrated in FIG. 7, the printing apparatus of this embodiment includes a photosensitive drum 1 that is a plate forming body for forming a rewritable plate and made of an amorphous silicon (a-Si) photosensitive body. A charger 2, an exposure unit 3, a developing unit 4, a thermo-compression-bonding unit 70, an ink roller 5, a charge eliminator 6, and a first cleaner 7 are arranged around the photosensitive drum 1. The exposure unit 3 is provided as a latent image forming unit for drawing a latent image on the surface of the photosensitive drum 1 that operates as plate forming body. The developing unit 4 is provided as a protrusion forming unit for forming a protrusion by selectively causing ink repellent particles 20 to adhere to the region where a latent image is formed on the surface of the photosensitive drum 1 that operates as plate forming body. The thermo-compression-bonding unit 70 heats and melts the ink repellent particles 20 that are made to adhere onto the photosensitive drum 1 and thermo-compression bonds the ink repellent particles 20 onto the photosensitive drum 1.

The ink roller 5 is provided as an ink feeding unit for feeding ink 21 onto the surface of the photosensitive drum 1 that operates as plate forming body. Additionally, a blanket cylinder 8 is arranged as intermediate transfer member for transferring the ink 21 supplied onto the surface of the photosensitive drum 1 that operates as plate forming body. Furthermore, a second cleaner 9 and an impression cylinder 10 that operates as pressing unit for pressing the ink 21 on the surface of the blanket cylinder 8 when the ink 21 is transferred onto a sheet of paper 11 that is a recording medium are arranged around the blanket cylinder 8. The blanket cylinder 8 and the impression cylinder 10 also operate as conveying unit for conveying the sheet of paper 11 that operates as recording medium.

The photosensitive drum 1, the ink roller 5, the blanket cylinder 8 and the impression cylinder 10 are driven to rotate in the sense of arrow in FIG. 7 by a motor (not shown) according to the digital signal transmitted from a host computer (not shown). Additionally, the sheet of paper 11 that operates as recording medium is conveyed to between the blanket cylinder 8 and the impression cylinder 10 by a conveying unit (not shown) in response to the above operation.

As in Embodiment 1, commercially available oil-based ink (sheetfed offset printing ink Diatone Ecopure SOY-HPJ available from Sakata Inx) is employed in this Embodiment 5 along with an amorphous silicon type photosensitive drum 1 that can reliably accommodate ink that contains solvent. The surface (surface protecting layer) of the amorphous silicon photosensitive drum 1 is formed by an amorphous material that is based on at least either silicon or carbon and hence it is ink-philic (oil-philic). The surface protecting layer can be formed by means of a high-frequency plasma CVD (chemical vapor deposition) method or a PCVD (plasma chemical vapor deposition) method.

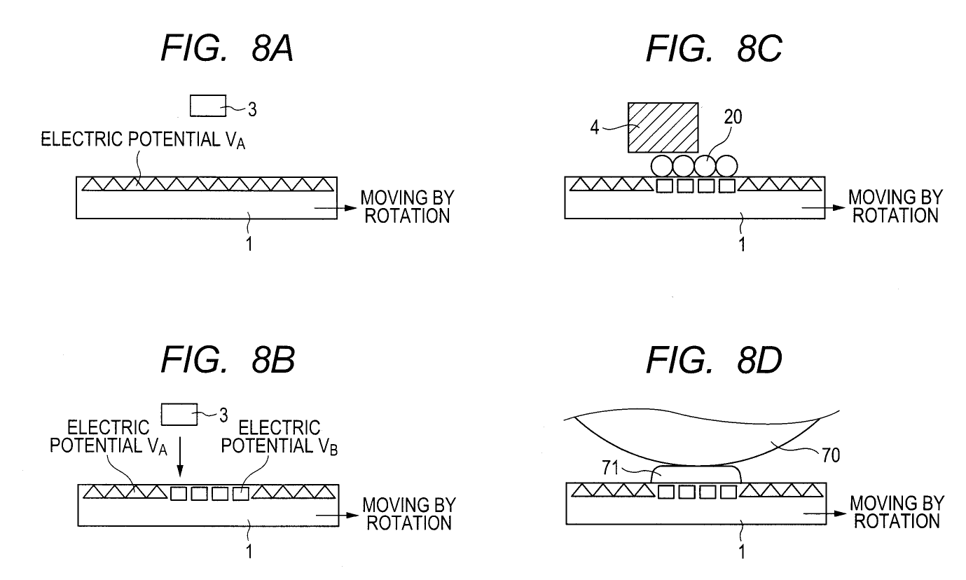

The surface of the photosensitive drum 1 is electrically charged to −600 V (electric potential V_{A} in FIG. 8A) by means of the charger 2 and subsequently an electrostatic latent image is drawn and formed at the position that corresponds to the non-image part (electric potential V_{B} in FIG. 8B) by means of the exposure unit 3. The electric potential V_{D} is about −30 V in this embodiment.

Thereafter, ink repellent particles 20 are made to adhere to the non-image part (the −30 V site) by reversal development, while the developing unit 4 storing ink repellent particles 20 that are electrically negatively charged by friction is held to −400 V (electric potential V_{C}) (See FIG. 8C). The principle of adhesion of ink repellent particles 20 is based on “the relationship between an electric field vector and a force vector”. Thus, an electric field vector that is directed from the exposure surface to the developing unit 4 is formed between the developing unit 4 of −400 V and the exposure surface of −30 V. Therefore, at the same time, a force vector operates to attract the ink repelling particles 20 that are located between the developing unit 4 and the non-image part (the −30 V site) to the non-image part (the −30 V site). On the other hand, an electric field vector that is directed from the developing unit 4 to the surface of −600 V is formed between the surface of −600 V that is not exposed and the developing unit 4 of −400 V. At the same time, the force vector operates to drive the ink repellent particles 20 away. This is the idea that is generally employed in the developing step of an electrophotography type printing process.

Ink repellent particles 20 are made to adhere by means of a so-called contact developing method. It is sufficient for the adherent force of ink repellent particles 20 to be adjusted under desired conditions by controlling the differences of the electric potentials of V_{A}, V_{B} and V_{C}, maintaining the relationship of formula (1) shown below for the magnitude relationship of the absolute values of the electric potentials when V_{A}, V_{B} and V_{C} are all negative electric potentials.

(absolute value of electric potential V_{A})>(absolute value of electric potential V_{C})>(absolute value of electric potential V_{B}) (1)

Resin made of hydrophilic polymer molecules such as polyvinyl alcohol, polyvinyl pyrrolidone, polyacrylic acid, nylon or cellulose may be applied to ink repellent particles 20 when oil-based ink 21 is employed. Alternatively, hydrophobic oil repellent resin made of fluorine or silicon may be applied to ink repellent particles 20. Still alternatively, commercially available particles may be applied to ink repellent particles 20. Such particles include, for example, polytetrafluoroethylene particles (Lubron (registered trademark) L-5F) available from Daikin Industries, powder of polytetrafluoroethylene (Teflon (registered trademark) 7A) available from Du Pont Mitsui Fluorochemicals, PFA particles (MP 10) available from Du Pont Mitsui Fluorochemicals, FEP particles (5328000) available from Du Pont and silicon powder (Torefil (registered trademark) E-606) available from DOW CORNIONG TORAY. Ink repellent particles 20 may be prepared in a manner as described below. Namely, (1) They may be prepared by melting/kneading desired resin, crushing it and subsequently dispersing it in liquid or spraying it in gas to turn it into particles or (2) They may be prepared by polymerizing monomers that corresponds to desired resin and at the same time turning it into particles. One or more than one oily ingredients, one or more than one magnetic substances and/or a charge control agent may be added internally and/or externally to ink repellent particles 20. Additives that may be mixed with ink repellent particles 20 include inorganic micro powder and inorganic micro powder and organic micro powder that are surface-treated. For this embodiment, powder of polytetrafluoroethylene (Teflon (registered trademark) 7A) available from Du Pont Mitsui Fluorochemicals is employed as ink repellent particles 20 after adding silica micro particles to it by 2 wt %.

Then, the ink repellent particles 20 that are made to adhere to the surface of the photosensitive drum 1 are heated to melt by the thermo-compression-bonding unit 70 and the ink repellent particles 20 are bonded to the surface of the photosensitive drum 1 by thermo-compression-bonding (see FIG. 8D). The principal ingredient of the ink repellent particles 20 is polytetrafluoroethylene and the melting point of polytetrafluoroethylene is 327° C. Therefore, the ink repellent particles 20 melt when they are heated to a temperature not lower than 327° C. The ink repellent particles 20 become to be hardly peeled off from the surface of the photosensitive drum 1 as the ink repellent particles 20 are heated to melt and bonded to the photosensitive drum 1 by thermo-compression-bonding by means of the thermo-compression-bonding unit 70.

Then, ink 21 is fed onto the photosensitive drum 1 by means of the ink roller 5. At this time, the ink roller 5 and the photosensitive drum 1 are desirably driven to rotate in a state where they substantially show no velocity difference in the circumferential direction at the contact position of them.

As the ink roller 5 and the photosensitive drum 1 are driven to rotate, there arises a state where the layer of the ink 21 adhering to the peripheral surface of the ink roller 5 is pressed against the photosensitive drum 1 where the compression-bonded ink repellent particles 71 adhere. Thus, force trying to eliminate each other takes place between the surface of the layer of the ink 21 on the surface of the ink roller 5 being pressed against the photosensitive drum 1 and the compression-bonded ink repellent particles 71 due to the ink-repellent property (the property of repelling ink). Therefore, the surface of the layer of the ink 21 and the compression-bonded ink repellent particles 71 are separated from each other due to the property of repelling ink (the ink-repellent property) in the process where the ink roller 5 and the photosensitive drum 1 are driven to rotate further to increase the gap between them in a radial direction.

On the other hand, the surface of the photosensitive drum 1 that is ink-philic is wetted by ink 21 and adsorbs the ink 21 (at the region where no compression-bonded ink repellent particles 71 are adhering). Thus, part of the thickness of the layer of the ink 21 adhering to the peripheral surface of the ink roller 5 is peeled off and the surface of the photosensitive drum 1 holds ink 21 in the process where the ink roller 5 and the photosensitive drum 1 are driven to rotate further to increase the gap between them in a radial direction. This process is same as the corresponding process of offset printing.

Namely, in this embodiment, the surfaces of the compression-bonded ink repellent particles 71 compression-bonded to the part of the surface where a latent image is formed by the developing unit 4 operating as protrusion forming unit for the photosensitive drum 1 that operates as plate forming body show a property of repelling the ink 21. On the other hand, the surface of the photosensitive drum 1 shows a property of not repelling ink 21. Particularly, oil-based ink 21 is employed and the surfaces of the ink repellent particles 20 are oil repellent, whereas the surface of the photosensitive drum 1 is oil-philic in this embodiment.

The thickness of the ink 21 held to the surface of the photosensitive drum 1 is controlled by an adjustment method of adjusting “the gap between the ink roller 5 and the photosensitive drum 1” and “the thickness of the layer of the ink 21 on the surface of the ink roller 5” that is being generally employed for offset printing.

Thereafter, the ink 21 held to the surface of the photosensitive drum 1 due to the wetted state of the photosensitive drum 1 and the ink repellent particles 71 compression-bonded to the surface of the photosensitive drum 1 move to the contact position of the drum 1 and the blanket cylinder 8. An ink-philic rubber material similar to the one that is generally employed for offset printing is wound around the surface of the blanket cylinder 8.

Thus, only part of the thickness of the layer of the ink 21 fed onto the photosensitive drum 1 is intermediately transferred onto the blanket cylinder 8 that is arranged with a desired gap between them. The quantity by which ink is transferred (the thickness of the layer of the ink 21) is controlled by an adjustment method of adjusting the “gap between the photosensitive drum 1 and the blanket cylinder 8” and so on that is being generally employed for offset printing. Of course, it also is related to adjustment of the thickness of the ink 21 held to the surface of the photosensitive drum 1 and hence “the gap between the ink roller 5 and the photosensitive drum 1” and “the thickness of the layer of the ink 21 on the surface of the ink roller 5” may also sometimes need to be adjusted. The plate cylinder 60 is made of durable metal such as aluminum. The surface of the plate cylinder 60 is desirably smooth.

Thereafter, the region on the photosensitive drum 1 where the intermediate transfer step has been completed moves to the position of the first cleaner 7. The first cleaner 7 is designed so as to collectively remove the compression-bonded ink repellent particles 71 and the ink 21 by way of a scraping off operation by means of a rubber blade and subsequently wash the region. Whenever necessary, a heater may be arranged in the inside of the first cleaner 7 or around the first cleaner 7 to melt the compression-bonded ink repellent particles 71 and remove them by the first cleaner 7. If necessary, a drying unit may be arranged downstream relative to the site where the cleaning step by the first cleaner 7 is conducted. Thereafter, the region on the photosensitive drum 1 is moved to the position of the charge eliminator 6 to eliminate the electric charge.

The image formed by the ink 21 that is intermediately transferred onto the blanket cylinder 8 is then transferred onto the sheet of paper 11 that is a recording medium pinched between the blanket cylinder 8 and the impression cylinder 10 to complete the printing. The region on the blanket cylinder 8 where the step of transferring the image onto the sheet of paper 11 has been completed is cleaned by the second cleaner 9 so as to remove the residual ink and restore the initial state. Then, ondemand digital offset printing is realized after completing an operation by the charger 2 and a step of proceeding to the exposure unit 3 for another time.

While single color printing using black ink is described above for the sake of convenience, full color printing can be realized by providing the arrangement of FIG. 7 also for inks 21 of cyan, magenta and yellow.

Thus, the printing method of this embodiment is a printing method of employing a rewritable plate. The method includes a first step of drawing a latent image on the surface of the photosensitive drum 1 that operates as plate forming body for forming a rewritable plate and a second step of causing ink repellent particles 20 to adhere to the surface of the photosensitive drum 1 according to the latent image to form a protrusion. The method further includes a third step of heating and melting the ink repellent particles 20 that are made to adhere to the surface of the photosensitive drum 1 operating as plate forming body and thermo-compression-bonding them to the surface of the photosensitive drum 1. The method also includes a fourth step of feeding ink 21 to the surface of the photosensitive drum 1 to form an image part and a fifth step of transferring the ink 21 on the surface of the photosensitive drum 1 onto the blanket cylinder 8 that operates as intermediate transfer member. The method additionally includes a sixth step of transferring the ink 21 on the surface of the blanket cylinder 8 onto a sheet of paper 11 that is a recording medium. Furthermore, the surfaces of the compression-bonded ink repellent particles 71 are made to have a property of repelling ink 21 whereas the surface of the photosensitive drum 1 is made to have a property of not repelling ink 21.

When same printed matters are to be output, high-speed printing can be realized by skipping the operations of the first cleaner 7, the charge eliminator 6, the charger 2, the exposure unit 3, the developing unit 4 and the thermo-compression-bonding unit 70 after executing a developing operation by means of the ink repellent particles 20.

### EXAMPLE 6

The above-described fifth embodiment adopts an electrostatic method for the latent image forming principle and, unlike the above-described first embodiment, is made to include a thermo-compression-bonding unit 70 for heating and melting the ink repellent particles 20 on the surface of the photosensitive drum 1 that operates as plate forming body. On the other hand, this embodiment adopts a magnetic method for the latent image forming principle and, unlike the above-described second embodiment, is made to include a thermo-compression-bonding unit 80 for heating and melting the ink repellent magnetic particles 50 on the surface of a magnetic drum 31 that operates as plate forming body as an example. Otherwise, the configuration of this embodiment is same as that of Embodiment 2.

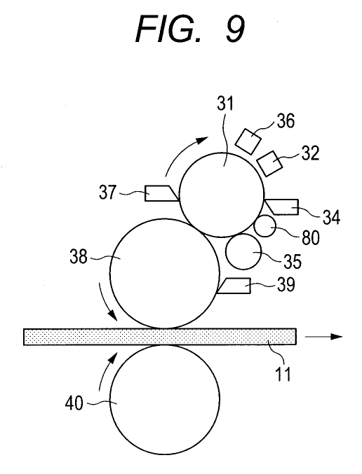

Now, this embodiment will be described below by referring to FIG. 9. As shown in FIG. 9, the printing apparatus of this embodiment includes a magnetic drum 31 that operates as plate forming body and a demagnetizer 36, a magnetic head 32 that operates as latent image forming unit, a developing unit 34 that operates as protrusion forming unit, an ink roller 35 that operates as ink feeding unit and a first cleaner 37 are arranged around the magnetic drum 31. Additionally, a second cleaner 39 and an impression cylinder 40 that operates as pressing unit are arranged around blanket cylinder 38 that operates as intermediate transfer member.

The magnetic drum 31, the ink roller 35, the blanket cylinder 38 and the impression cylinder 40 are driven to rotate in the sense of arrow in FIG. 9 by a motor (not shown) according to the digital signal transmitted from a host computer (not shown). Additionally, the sheet of paper 11 that operates as recording medium is conveyed by a conveying unit (not shown) in response to the above operation.

Commercially available oil-based ink (sheetfed offset printing ink Diatone Ecopure SOY-HPJ available from Sakata Inx) 21 is employed also in this embodiment and the magnetic drum 31 is overcoated with polystyrene, although any appropriate ink-philic material other than polystyrene such as polyethylene, polypropylene, polymethylmethacrylate, polyethylene terephthalate, polyimide may alternatively be selected and employed as overcoat. The underlayer thereof is undercoated by a magnetic material such as ferrite.

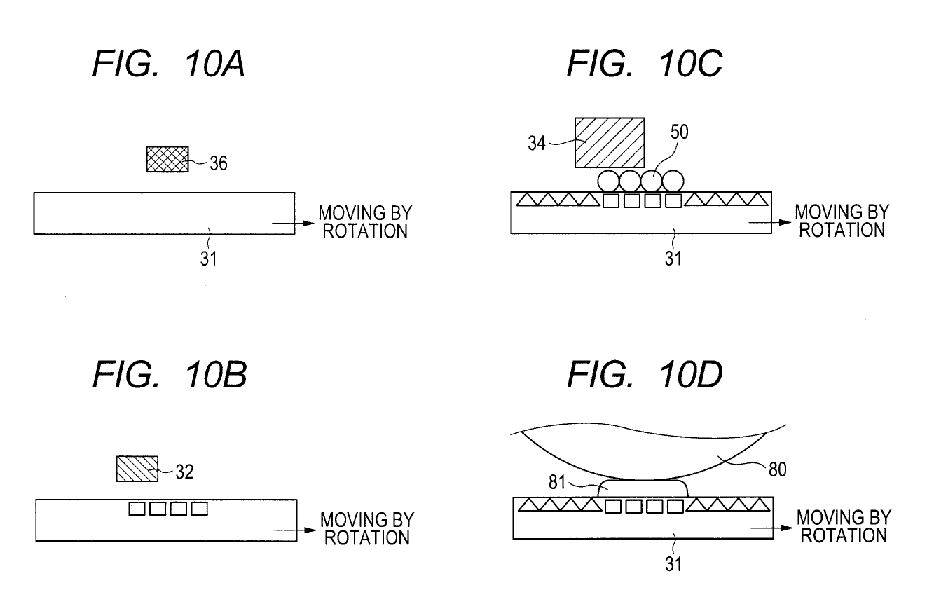

A demagnetizing process is executed on the magnetic drum 31 by the demagnetizer 36 as shown in FIG. 10A and subsequently the surface of the magnetic drum 31 is magnetized by the magnetic head 32 in the region that corresponds to a non-image part to form a magnetic latent image as shown in FIG. 10B. Thereafter, ink repellent magnetic particles 50 stored in the developing unit 34 are made to adhere to the magnetic latent image by means of magnetic force as shown in FIG. 10C.

The above-described ink repellent magnetic particles 50 are preferably a ferromagnetic substance such as ferrite, manganese-zinc ferrite, manganese-nickel ferrite, magnetite, nickel or permalloy. Preferably, the ink repellent magnetic particles 50 show a high magnetic permeability and the surfaces thereof are treated for ink repellency by means of fluorine or silicon. When the surfaces of the ink repellent magnetic particles 50 are treated for ink repellency by means of polytetrafluoroethylene, which is a fluorine resin, the ink repellent magnetic particles 50 are molten by heating them to a temperature not lower than 32720 C. because the melting point of polytetrafluoroethylene is 327° C.

Thereafter, the ink repellent magnetic particles 50 that are made to adhere to the surface of the magnetic drum 31 are heated to melt by means of the thermo-compression-bonding unit 80 and then the ink repellent magnetic particles 50 are thermo-compression-bonded to the surface of the magnetic drum 31 by means of the thermo-compression-bonding unit 80 (see FIG. 10D). The compression-bonded ink repellent magnetic particles 81 become to be hardly peeled off from the surface of the magnetic drum 31 as the ink repellent magnetic particles 50 are heated to melt and firmly bonded to the magnetic drum 31 to become compression-bonded ink repellent magnetic particles 81 by means of the thermo-compression-bonding unit 80.

Then, ink 21 is fed onto the magnetic drum 31 by means of the ink roller 35. At this time, the ink roller 35 and the magnetic drum 31 are desirably driven to rotate in a state where they substantially show no velocity difference in the circumferential direction at the contact position of them.

As the ink roller 35 and the magnetic drum 31 are driven to rotate, there arises a state where the layer of the ink 21 adhering to the peripheral surface of the ink roller 35 is pressed against the magnetic drum 31 where the compression-bonded ink repellent magnetic particles 81 firmly adhere. Thus, force trying to eliminate each other takes place between the surface of the layer of the ink 21 on the surface of the ink roller 35 being pressed against the magnetic drum 31 and the compression-bonded ink repellent magnetic particles 81 due to the ink-repellent property (the property of repelling ink 21). Therefore, the surface of the layer of the ink 21 and the compression-bonded ink repellent magnetic particles 81 are separated from each other due to the property of repelling ink (the ink-repellent property) in the process where the ink roller 35 and the magnetic drum 31 are driven to rotate further to increase the gap between them in a radial direction.

On the other hand, the surface of the magnetic drum 31 that is ink-philic is wetted by ink 21 and adsorbs the ink 21 (at the region where no compression-bonded ink repellent magnetic particles 81 are adhering). Thus, part of the thickness of the layer of the ink 21 adhering to the peripheral surface of the ink roller 35 is peeled off and the surface of the magnetic drum 31 holds ink 21 in the process where the ink roller 35 and the magnetic drum 31 are driven to rotate further to increase the gap between them in a radial direction. This process is same as the corresponding process of offset printing.

The thickness of the ink 21 held to the surface of the magnetic drum 31 is controlled by an adjustment method of adjusting “the gap between the ink roller 35 and the magnetic drum 31” and “the thickness of the layer of the ink 21 on the surface of the ink roller 35” that is being generally employed for offset printing.

Thereafter, the ink 21 held to the surface of the magnetic drum 31 due to the wetted state of the magnetic drum 31 and the compression-bonded ink repellent magnetic particles 81 move to the contact position of the drum 31 and the blanket cylinder 38. An ink-philic rubber material similar to the one that is generally employed for offset printing is wound around the surface of the blanket cylinder 38.

Thus, only part of the thickness of the layer of the ink 21 fed onto the magnetic drum 31 is intermediately transferred onto the blanket cylinder 38 that is arranged with a desired gap between them. The quantity by which ink is transferred (the thickness) is controlled by an adjustment method of adjusting the “gap between the magnetic drum 31 and the blanket cylinder 38” and so on that is being generally employed for offset printing. Of course, it also is related to adjustment of the thickness of the ink 21 held to the surface of the magnetic drum 31 and hence “the gap between the ink roller 35 and the magnetic drum 31” and “the thickness of the layer of the ink 21 on the surface of the ink roller 35” may also sometimes need to be adjusted.

Thereafter, the region on the magnetic drum 31 where the intermediate transfer step has been completed moves to the position of the first cleaner 37. The first cleaner 37 is designed so as to collectively remove the ink repellent magnetic particles 50 and the ink 21 by way of a scraping off operation by means of a rubber blade and subsequently wash the region. Whenever necessary, a heater may be arranged in the inside of the first cleaner 37 or around the first cleaner 37 to melt the compression-bonded ink repellent magnetic particles 81 and remove them by the first cleaner 37. If necessary, a drying unit may be arranged downstream relative to the site where the cleaning step by the first cleaner 37 is conducted. Thereafter, the region on the magnetic drum 31 is moved to the position of the demagnetizer 36 for demagnetization.

The image formed by the ink 21 that is intermediately transferred onto the blanket cylinder 38 is then transferred onto the sheet of paper 11 that is a recording medium pinched between the blanket cylinder 38 and the impression cylinder 40 to complete the printing. The region on the blanket cylinder 38 where the step of transferring the image onto the sheet of paper 11 has been completed is cleaned by the second cleaner 39 so as to remove the residual ink 21 and restore the initial state. Then, ondemand digital offset printing is realized after completing an operation by the demagnetizer 36 and a step of proceeding to the magnetic head 32 for another time.

While single color printing using black ink is described above for the sake of convenience, full color printing can be realized by providing the arrangement of FIG. 9 also for inks of cyan, magenta and yellow. When same printed matters are to be output, high-speed printing can be realized by skipping the operations of the first cleaner 37, the demagnetizer 36, the magnetic head 32, the developing unit 44 and the thermo-compression-bonding unit 80 after executing a developing operation by means of the ink repellent magnetic particles 50.

An electrostatic method and a magnetic method are described as examples for the latent image forming principle underlying the operation of forming a protrusion on the surface of a plate forming body by selectively causing ink repellent particles 20 and 50 to adhere thereto in the above-described fifth and sixth embodiments. However, some other principle may alternatively be employed for the purpose of the present invention.

### EXAMPLE 7

In this embodiment unlike in Embodiment 6, water-based ink is employed as ink and the surfaces of ink repellent magnetic particles 50 are made water repellent while the surface of the magnetic drum 31 that operates as plate forming body is made hydrophilic as an example.

Commercially available water-based ink (available from Fuji Ink Manufacturing Co., Ltd.: NSG-T Type) is employed in this embodiment as an example. Otherwise, the configuration and the principle of operation of this embodiment are same as those of the above-described fifth embodiment. Note, however, that the surface of the magnetic drum 31 that operates as plate forming body is coated with hydrophilic polyvinyl alcohol, although it may alternatively be coated with a hydrophilic polymer material other than polyvinyl alcohol that is selected from polyvinyl pyrrolidone, polyacrylic acid, cellulose, nylon and so on. Additionally, the coat surface may be made to be porous or have micro undulations to improve the hydrophilicity. The surfaces of ink repellent magnetic particles 50 are made water repellent and treated by fluorine or silicon so as turn them hydrophobic.

Full color printing can be realized by providing the arrangement of FIG. 9 also for water-based inks of black, cyan, magenta and yellow. When same printed matters are to be output, high-speed printing can be realized by skipping the operations of the first cleaner 37, the demagnetizer 36, the magnetic head 32, the developing unit 34 and the thermo-compression-bonding unit 80 after executing a developing operation by means of the ink repellent magnetic particles 50.

### EXAMPLE 8

In this embodiment, the ink repellent particles on photosensitive drum 1 that is formed by an amorphous silicon (a-Si) photosensitive body to operates as plate forming body are transferred to a second plate forming body having durability such as aluminum as an example. Otherwise, the configuration of this embodiment is same as that of Embodiment 1 and hence will not be described any further.

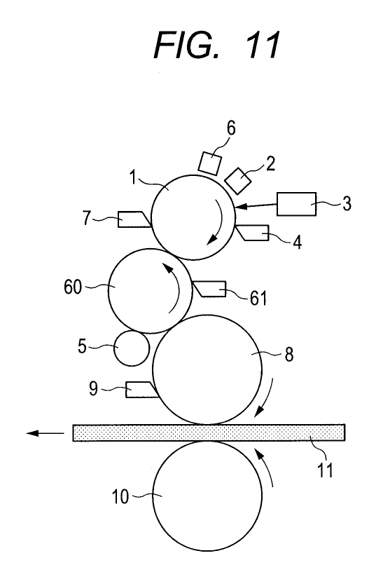

As shown in FIG. 11, the printing apparatus of this embodiment includes a photosensitive drum 1 that is a plate forming body for forming a rewritable plate and made of an amorphous silicon (a-Si) photosensitive body. A charger 2, an exposure unit 3, a developing unit 4, a plate cylinder 60, a charge eliminator 6 and a first cleaner 7 are arranged around the photosensitive drum 1. The exposure unit 3 is provided as a latent image forming unit for drawing a latent image on the surface of the photosensitive drum 1 that operates as plate forming body. The developing unit 4 is provided as a protrusion forming unit for forming a protrusion by selectively causing ink repellent particles 20 to adhere to the region where a latent image is formed on the surface of the photosensitive drum 1 that operates as plate forming body. The developing unit 4 additionally transfers the ink repellent particles 20 adhering onto the surface of the photosensitive drum 1 that operates as plating forming body to the surface of the plate cylinder 60 that operates as the second plate forming body. The ink roller 5 is provided as an ink feeding unit for feeding ink 21 onto the surface of the plate cylinder 60 that operates as the second plate forming body. A third cleaner 61 is arranged around the plate cylinder 60 that operates as the second plate forming body. A blanket cylinder 8 is arranged as intermediate transfer member for transferring the ink 21 supplied onto the surface of the plate cylinder 60 that operates as the second plate forming body. Furthermore, a second cleaner 9 and an impression cylinder 10 that operates as pressing unit for pressing the ink 21 on the surface of the blanket cylinder 8 when the ink 21 is transferred onto a sheet of paper 11 that is a recording medium are arranged around the blanket cylinder 8. The blanket cylinder 8 and the impression cylinder 10 also operate as conveying unit for conveying the sheet of paper 11 that operates as recording medium.

The photosensitive drum 1, the plate cylinder 60, the ink roller 5, the blanket cylinder 8 and the impression cylinder 10 are driven to rotate in the sense of arrow in FIG. 11 by a motor (not shown) according to the digital signal (the image part data is mirror image data) transmitted from a host computer (not shown). Additionally, the sheet of paper 11 that operates as recording medium is conveyed to between the blanket cylinder 8 and the impression cylinder 10 by a conveying unit (not shown) in response to the above operation.

As in Embodiment 1, commercially available oil-based ink (sheetfed offset printing ink Diatone Ecopure SOY-HPJ available from Sakata Inx) is employed. Also as in Embodiment 1, an amorphous silicon type photosensitive drum 1 that can reliably accommodate ink that contains solvent is employed.

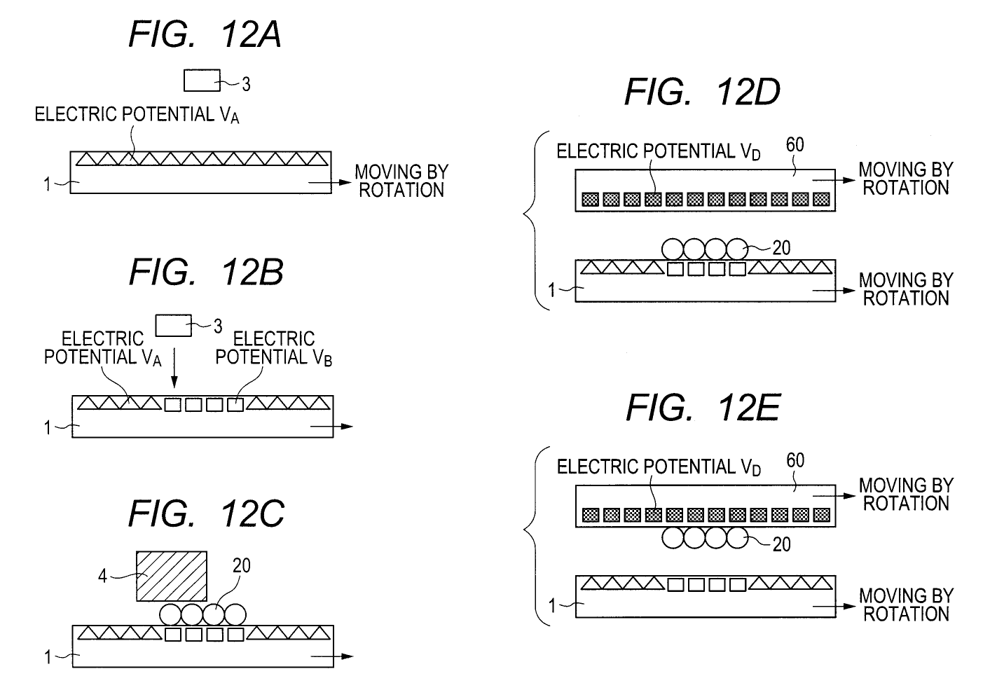

As in Embodiment 1, the surface of the photosensitive drum 1 is electrically charged to −600 V (electric potential V_{A} in FIG. 12A) by means of the charger 2 and subsequently an electrostatic latent image is drawn and formed at the position that corresponds to the non-image part (electric potential V_{B} in FIG. 12B) by means of the exposure unit 3. The electric potential V_{B} is about −30 V in this embodiment.

Thereafter, ink repellent particles 20 are made to adhere to the non-image part (the −30 V site) by reversal development, while the developing unit 4 storing ink repellent particles 20 that are electrically negatively charged by friction is held to −400 V (electric potential V_{C}) (See FIG. 12C). The principle of adhesion of ink repellent particles 20 is based on “the relationship between an electric field vector and a force vector”. Thus, an electric field vector that is directed from the exposure surface to the developing unit 4 is formed between the developing unit 4 of −400 V and the exposure surface of −30 V (electric potential V_{B}). Therefore, at the same time, a force vector operates to attract the ink repelling particles 20 located between the developing unit 4 and the non-image part (the −30 V site) to the non-image part (the −30 V site). On the other hand, an electric field vector that is directed from the developing unit 4 to the surface of −600 V is formed between the surface of −600 V that is not exposed and the developing unit 4 of −400 V. At the same time, the force vector operates to drive the ink repellent particles away. This is the idea that is generally employed in the developing step of an electrophotography type printing process.

Ink repellent particles 20 are made to adhere by means of a so-called contact developing method. It is sufficient for the adherent force of ink repellent particles 20 to be adjusted under desired conditions by controlling the differences of the electric potentials of V_{A}, V_{B} and V_{C}, maintaining the relationship of formula (1) shown below for the magnitude relationship of the absolute values of the electric potentials.

(absolute value of electric potential V_{A})>(absolute value of electric potential V_{C})>(absolute value of electric potential V_{B}) (1)

As in Embodiment 1, resin made of hydrophilic polymer molecules such as polyvinyl alcohol, polyvinyl pyrrolidone, polyacrylic acid, nylon or cellulose may be applied to ink repellent particles 20 when oil-based ink 21 is employed. Alternatively, hydrophobic oil repellent resin made of fluorine or silicon may be applied to ink repellent particles 20. Still alternatively, commercially available particles may be applied to ink repellent particles 20. Such particles include, for example, polytetrafluoroethylene particles (Lubron (registered trademark) L-5F) available from Daikin Industries, powder of polytetrafluoroethylene (Teflon (registered trademark) 7A) available from Du Pont Mitsui Fluorochemicals, PFA particles (MP 10) available from Du Pont Mitsui Fluorochemicals, FEP particles (5328000) available from Du Pont and silicon powder (Torefil (registered trademark) E-606) available from DOW CORNIONG TORAY. Ink repellent particles 20 may be prepared in a manner as described below. Namely, (1) they may be prepared by melting/kneading desired resin, crushing it and subsequently dispersing it in liquid or spraying it in gas to turn it into particles or (2) They may be prepared by polymerizing monomers that corresponds to desired resin and at the same time turning it into particles. One or more than one oily ingredients, one or more than one magnetic substances and/or a charge control agent may be added internally and/or externally to ink repellent particles 20. Additives that may be mixed with ink repellent particles 20 include inorganic micro powder and inorganic micro powder and organic micro powder that are surface-treated. For this embodiment, powder of polytetrafluoroethylene (Teflon (registered trademark) 7A) available from Du Pont Mitsui Fluorochemicals is employed as ink repellent particles 20 after adding silica micro particles to it by 2 wt %.

Then, the ink repellent particles 20 are transferred from the surface of the photosensitive drum 1 to the surface of the plate cylinder 60 on the basis of the principle of transfer charger. More specifically, the ink repellent particles 20 that are electrically negatively charged by friction and adhering to the surface of the photosensitive drum 1 by image force are driven to move to a position between the photosensitive drum 1 and the plate cylinder 60 (FIG. 12D). The surface of the plate cylinder 60 is held to −5 V (electric potential V_{D}) and the particles 20 are transferred onto the surface of the plate cylinder 60 at a position in the gap between the photosensitive drum 1 and the plate cylinder 60 (FIG. 12E). This is also based on “the relationship between an electric field vector and a force vector” and an electric field vector that is directed from the plate cylinder 60 to the surface of the photosensitive drum 1 (exposure section) is formed between the surface of the photosensitive drum 1 of −30 V (potential V_{B}) and the plate cylinder 60 of −5 V (potential V_{D}). Therefore, at the same time, a force vector operates to attract the ink repelling particles 20 located between the plate cylinder 60 and the surface of the photosensitive drum (exposure section) to the surface of the plate cylinder 60. It is sufficient for the adherent force of ink repellent particles 20 relative to the plate cylinder 60 to be adjusted by controlling the difference of the electric potentials of V_{B} and V_{D}, maintaining the relationship of formula (2) shown below for the magnitude relationship of the absolute values of the electric potentials.

(absolute value of electric potential V_{B})>(absolute value of electric potential V_{D}) (2)

Then, ink 21 is fed onto the plate cylinder 60 by means of the ink roller 5. At this time, the ink roller 5 and the plate cylinder 60 are desirably driven to rotate in a state where they substantially show no velocity difference in the circumferential direction at the contact position of them.

As the ink roller 5 and the plate cylinder 60 are driven to rotate, there arises a state where the layer of the ink 21 adhering to the peripheral surface of the ink roller 5 is pressed against the plate cylinder 60 where the ink repellent particles 20 adhere. Thus, force trying to eliminate each other takes place between the surface of the layer of the ink 21 on the surface of the ink roller 5 being pressed against the plate cylinder 60 and the ink repellent particles 20 due to the ink-repellent property (the property of repelling ink). Therefore, the surface of the layer of the ink 21 and the ink repellent particles 20 are separated from each other due to the property of repelling ink (the ink-repellent property) in the process where the ink roller 5 and the plate cylinder 60 are driven to rotate further to increase the gap between them in a radial direction.

On the other hand, the surface of the plate cylinder 60 that is ink-philic is wetted by ink 21 and adsorbs the ink 21 (at the region where no ink repellent particles 20 are adhering). Thus, though a part of the thickness of the layer of the ink 21 adhering to the peripheral surface of the ink roller 5 may be peeled off, the surface of the plate cylinder 60 holds ink 21 in the process where the ink roller 5 and the plate cylinder 60 are driven to rotate further to increase the gap between them in a radial direction. This process is same as the corresponding process of offset printing.

Namely, in this embodiment, the surfaces of the ink repellent particles 20 show a property of repelling the ink 21 and the surface of the plate cylinder 60 shows a property of not repelling ink 21. Particularly, oil-based ink 21 is employed and the surfaces of the ink repellent particles 20 are oil repellent, whereas the surface of the plate cylinder 60 is oil-philic in this embodiment.

The thickness of the ink 21 held to the surface of the plate cylinder 60 is controlled by an adjustment method of adjusting “the gap between the ink roller 5 and the plate cylinder 60” and “the thickness of the layer of the ink 21 on the surface of the ink roller 5” that is being generally employed for offset printing.

Thereafter, the ink 21 held to the surface of the plate cylinder 60 due to the wetted state of the plate cylinder 60 and the ink repellent particles 20 held to the surface of the plate cylinder 60 by image force of electromagnetics move to the contact position of the plate cylinder 60 and the blanket cylinder 8. An ink-philic rubber material similar to the one that is generally employed for offset printing is wound around the surface of the blanket cylinder 8.

Thus, only part of the thickness of the layer of the ink 21 fed onto the plate cylinder 60 is intermediately transferred onto the blanket cylinder 8 that is arranged with a desired gap between them. The quantity by which ink is transferred (the thickness of the layer of the ink 21) is controlled by an adjustment method of adjusting the “gap between the plate cylinder 60 and the blanket cylinder 8” and so on that is being generally employed for offset printing. Of course, it also is related to adjustment of the thickness of the ink 21 held to the surface of the plate cylinder 60 and hence “the gap between the ink roller 5 and the plate cylinder 60” and “the thickness of the layer of the ink 21 on the surface of the ink roller 5” may also sometimes need to be adjusted.

Thereafter, the region on the photosensitive drum 1 where the transfer step to the plate cylinder 60 has been completed moves to the position of the first cleaner 7. The first cleaner 7 is designed to operate for cleaning by way of a scraping off operation by means of a rubber blade. Thereafter, the region on the photosensitive drum 1 is moved to the position of the charge eliminator 6 to eliminate the electric charge.

The region on the plate cylinder 60 where the transfer step to the blanket cylinder 8 has been completed moves to the position of the third cleaner 61. The third cleaner 61 is designed so as to collectively remove the ink repellent particles 20 and the ink 21 by way of a scraping off operation by means of a rubber blade and subsequently wash the region. If necessary, a drying unit may be arranged downstream relative to the site where the cleaning step by the third cleaner 61 is conducted.

The image formed by the ink 21 that is intermediately transferred onto the blanket cylinder 8 is then transferred onto the sheet of paper 11 that is a recording medium pinched between the blanket cylinder 8 and the impression cylinder 10 to complete the printing. The region on the blanket cylinder 8 where the step of transferring the image onto the sheet of paper 11 has been completed is cleaned by the second cleaner 9 so as to remove the residual ink and restore the initial state. Then, ondemand digital offset printing is realized after completing an operation by the charger 2 and a step of proceeding to the exposure unit 3 for another time.

While single color printing using black ink is described above for the sake of convenience, full color printing can be realized by providing the arrangement of FIG. 11 also for inks 21 of cyan, magenta and yellow.

When compared with a photosensitive drum 1, the operation of causing ink to adhere and that of removing ink can be conducted on the plate cylinder 60 to prevent the photosensitive drum 1 from degrading by using the plate cylinder 60 that is made of a highly durable material such as aluminum as the second plate forming body. Then, as a result, the photosensitive drum 1 can be operated for a long period of time to reduce the running cost of the apparatus.

Thus, the printing method of this embodiment is a printing method of employing a rewritable plate. The method includes a first step of drawing a latent image on the surface of the photosensitive drum 1 that operates as plate forming body for forming a rewritable plate and a second step of causing ink repellent particles 20 to adhere to the surface of the photosensitive drum 1 according to the latent image to form a protrusion. The method further includes a third step of transferring the ink repellent particles 20 adhering to the surface of the photosensitive drum 1 to the surface of the plate cylinder 60 that operates as the second plate forming body to form an image part. The method also includes a fourth step of feeding ink 21 to the surface of the plate cylinder 60 to form an image part and a fifth step of transferring the ink 21 on the surface of the plate cylinder 60 onto the blanket cylinder 8 that operates as intermediate transfer member. The method additionally includes a sixth step of transferring the ink 21 on the surface of the blanket cylinder 8 onto a sheet of paper 11 that is a recording medium. Furthermore, the surfaces of the ink repellent particles 20 are made to have a property of repelling ink 21 whereas the surface of the plate cylinder 60 is made to have a property of not repelling ink 21.

When same printed matters are to be output, high-speed printing can be realized by skipping the operations of the first cleaner 7, the charge eliminator 6, the charger 2, the exposure unit 3, the developing unit 4, the second cleaner 9 and the third cleaner 61 after executing a developing operation by means of the ink repellent particles 20.

### EXAMPLE 9

In this embodiment, the ink repellent particles 20 on the plate cylinder 60 that operates as the second plate forming body are heated to melt and thermo-compression-bonded onto the plate cylinder 60 as an example. Otherwise, the configuration of this embodiment is same as that of Embodiment 8.

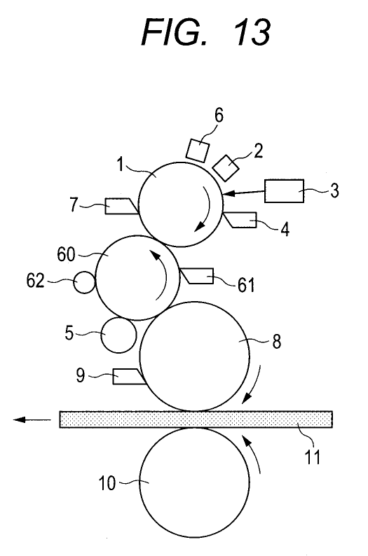

As shown in FIG. 13, the printing apparatus of this embodiment includes a photosensitive drum 1 that is a plate forming body for forming a rewritable plate and made of an amorphous silicon (a-Si) photosensitive body. A charger 2, an exposure unit 3, a developing unit 4, a plate cylinder 60, a charge eliminator 6 and a first cleaner 7 are arranged around the photosensitive drum 1. The exposure unit 3 is provided as a latent image forming unit for drawing a latent image on the surface of the photosensitive drum 1 that operates as plate forming body. The developing unit 4 is provided as a protrusion forming unit for forming a protrusion by selectively causing ink repellent particles 20 to adhere to the region where a latent image is formed on the surface of the photosensitive drum 1 that operates as plate forming body. Additionally, the ink repellent particles 20 adhering to the surface of the photosensitive drum 1 that operates as plate forming body are transferred onto the surface of the plate cylinder 60 that operates as the second plate forming body. The ink roller 5 is provided as an ink feeding unit for feeding ink 21 onto the surface of the plate cylinder 60 that operates as the second plate forming body. A third cleaner 61 and a thermo-compression-bonding unit 62 are arranged around the plate cylinder 60 that operates as the second plate forming body. The thermo-compression-bonding unit 62 heats and melts the ink repellent particles 20 that are made to adhere onto the plate cylinder 60 and thermo-compression bonds the ink repellent particles 20 onto the plate cylinder 60. A blanket cylinder 8 is arranged as intermediate transfer member for transferring the ink 21 supplied onto the surface of the plate cylinder 60 that operates as the second plate forming body. Furthermore, a second cleaner 9 and an impression cylinder 10 that operates as a pressing unit for pressing the ink 21 on the surface of the blanket cylinder 8 when the ink 21 is transferred onto a sheet of paper 11 that is a recording medium are arranged around the blanket cylinder 8. The blanket cylinder 8 and the impression cylinder 10 also operate as a conveying unit for conveying the sheet of paper 11 that operates as recording medium.

The photosensitive drum 1, the plate cylinder 60, the ink roller 5, the blanket cylinder 8 and the impression cylinder 10 are driven to rotate in the sense of arrow in FIG. 13 by a motor (not shown) according to the digital signal (the image part data is mirror image data) transmitted from a host computer (not shown). Additionally, the sheet of paper 11 that operates as recording medium is conveyed to between the blanket cylinder 8 and the impression cylinder 10 by a conveying unit (not shown) in response to the above operation.

As in Embodiment 8, commercially available oil-based ink (sheetfed offset printing ink Diatone Ecopure SOY-HPJ available from Sakata Inx) is employed. Also as in Embodiment 1, an amorphous silicon type photosensitive drum 1 that can reliably accommodate ink that contains solvent is employed.

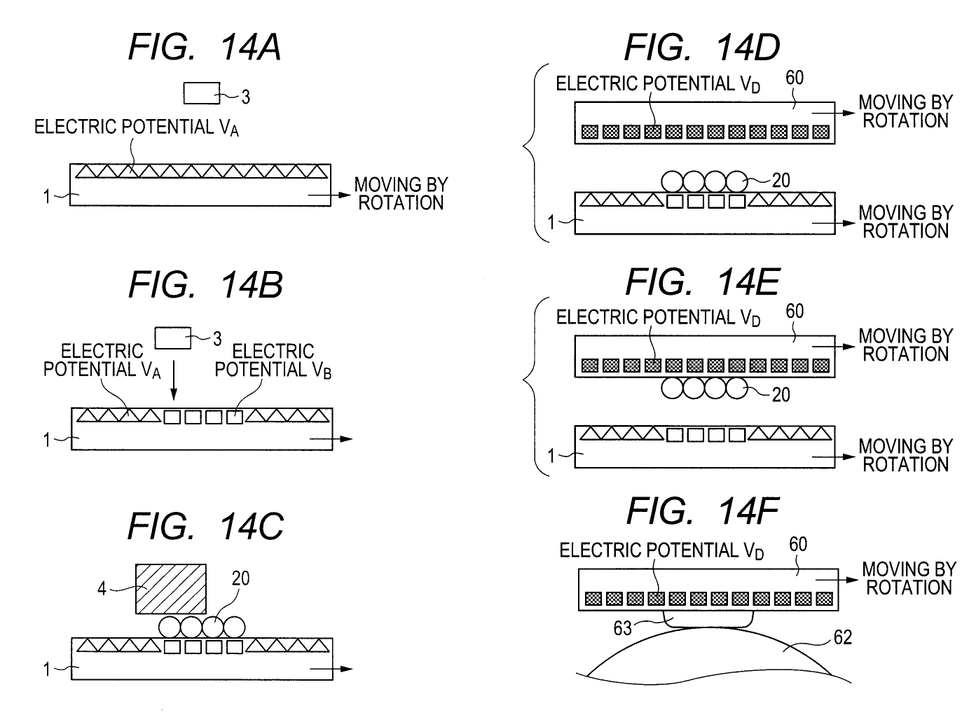

As in Embodiment 8, the surface of the photosensitive drum 1 is electrically charged to −600V (electric potential V_{A} in FIG. 14A) by means of the charger 2 and subsequently an electrostatic latent image is drawn and formed at the position that corresponds to the non-image part (electric potential V_{B} in FIG. 14B) by means of the exposure unit 3. The electric potential V_{B} is about −30 V in this embodiment.

Thereafter, ink repellent particles 20 are made to adhere to the non-image part (the −30 V site) by reversal development, while the developing unit 4 storing ink repellent particles 20 that are electrically negatively charged by friction is held to −400 V (electric potential V_{C}) (See FIG. 14C). The principle of adhesion of ink repellent particles 20 is based on “the relationship between an electric field vector and a force vector”. Thus, an electric field vector that is directed from the exposure surface to the developing unit 4 is formed between the developing unit 4 of −400 V (electric potential V_{C}) and the exposure surface of −30 V (electric potential V_{B}). Therefore, at the same time, a force vector operates to attract the ink repelling particles 20 located between the developing unit 4 and the non-image part (the −30 V site) to the non-image part (the −30 V site). On the other hand, an electric field vector that is directed from the developing unit 4 to the surface of −600 V is formed between the surface of −600 V that is not exposed and the developing unit 4 of −400 V. At the same time, the force vector operates to drive the ink repellent particles 20 away. This is the idea that is generally employed in the developing step of an electrophotography type printing process.

Ink repellent particles 20 are made to adhere by means of a so-called contact developing method. It is sufficient for the adherent force of ink repellent particles 20 to be adjusted under desired conditions by controlling the differences of the electric potentials of V_{A}, V_{B} and V_{C}, maintaining the relationship of formula (1) shown below for the magnitude relationship of the absolute values of the electric potentials.

(absolute value of electric potential V_{A})>(absolute value of electric potential V_{C})>(absolute value of electric potential V_{B}) (1)

Then, the ink repellent particles 20 are transferred from the surface of the photosensitive drum 1 to the surface of the plate cylinder 60 on the basis of the principle of transfer charger. More specifically, the ink repellent particles 20 that are electrically negatively charged by friction and adhering to the surface of the photosensitive drum 1 by image force are driven to move to a position between the photosensitive drum 1 and the plate cylinder 60 (FIG. 14D). The surface of the plate cylinder 60 is held to −5V (electric potential V_{D}) and the particles 20 are transferred onto the surface of the plate cylinder 60 at a position in the gap between the photosensitive drum 1 and the plate cylinder 60 (FIG. 14E). This is also based on “the relationship between an electric field vector and a force vector” and an electric field vector that is directed from the plate cylinder 60 to the surface of the photosensitive drum 1 (exposure section) is formed between the surface of the photosensitive drum 1 of −30 V (potential V_{B}) and the plate cylinder 60 of −5 V (potential V_{D}). Therefore, at the same time, a force vector operates to attract the ink repelling particles 20 located between the plate cylinder 60 and the surface of the photosensitive drum 1 (exposure section) to the surface of the plate cylinder 60. It is sufficient for the adherent force of ink repellent particles 20 relative to the plate cylinder 60 to be adjusted by controlling the difference of the electric potentials of V_{B} and V_{D}, maintaining the relationship of formula (2) shown below for the magnitude relationship of the absolute values of the electric potentials. The above description is same as the one given above for Embodiment 8.

(absolute value of electric potential V_{B})>(absolute value of electric potential V_{D}) (2)

Then, the ink repellent particles 20 that are made to adhere to the surface of the plate cylinder 60 are heated to melt by the thermo-compression-bonding unit 62 and the ink repellent particles 20 are bonded to the surface of the plate cylinder 60 by thermo-compression-bonding by means of the thermo-compression-bonding unit (see FIG. 14F). The principal ingredient of the ink repellent particles 20 is polytetrafluoroethylene and the melting point of polytetrafluoroethylene is 327° C. Therefore, the ink repellent particles 20 melt when they are heated to a temperature not lower than 327° C. The ink repellent particles 20 become to be hardly peeled off from the surface of the plate cylinder 60 as the ink repellent particles 20 are heated to melt and bonded to the plate cylinder 60 by thermo-compression-bonding by means of the thermo-compression-bonding unit 62.

Then, ink 21 is fed onto the plate cylinder 60 by means of the ink roller 5. At this time, the ink roller 5 and the plate cylinder 60 are desirably driven to rotate in a state where they substantially show no velocity difference in the circumferential direction at the contact position of them.

As the ink roller 5 and the plate cylinder 60 are driven to rotate, there arises a state where the layer of the ink 21 adhering to the peripheral surface of the ink roller 5 is pressed against the plate cylinder 60 where the thermo-compression-bonded ink repellent particles 63 adhere. Thus, force trying to eliminate each other takes place between the surface of the layer of the ink 21 on the surface of the ink roller 5 being pressed against the plate cylinder 60 and the compression-bonded ink repellent particles 63 due to the ink-repellent property (the property of repelling ink). Therefore, the surface of the layer of the ink 21 and the compression-bonded ink repellent particles 63 are separated from each other due to the property of repelling ink (the ink-repellent property) in the process where the ink roller 5 and the plate cylinder 60 are driven to rotate further to increase the gap between them in a radial direction.

On the other hand, the surface of the plate cylinder 60 that is ink-philic is wetted by ink 21 and adsorbs the ink 21 (at the region where no ink repellent particles 20 are adhering). Thus, though a part of the thickness of the layer of the ink 21 adhering to the peripheral surface of the ink roller 5 may be peeled off, the surface of the plate cylinder 60 holds ink 21 in the process where the ink roller 5 and the plate cylinder 60 are driven to rotate further to increase the gap between them in a radial direction. This process is same as the corresponding process of offset printing.

Namely, in this embodiment, the surfaces of the compression-bonded ink repellent particles 63 show a property of repelling the ink 21 and the surface of the plate cylinder 60 shows a property of not repelling ink 21. Particularly, oil-based ink 21 is employed and the surfaces of the ink repellent particles 20 are oil repellent, whereas the surface of the plate cylinder 60 is oil-philic in this embodiment.

The thickness of the ink 21 held to the surface of the plate cylinder 60 is controlled by an adjustment method of adjusting “the gap between the ink roller 5 and the plate cylinder 60” and “the thickness of the layer of the ink 21 on the surface of the ink roller 5” that is being generally employed for offset printing.

Thereafter, the ink 21 held to the surface of the plate cylinder 60 due to the wetted state of the plate cylinder 60 and the ink repellent particles 20 held to the surface of the plate cylinder 60 by image force of electromagnetics move to the contact position of the plate cylinder 60 and the blanket cylinder 8. An ink-philic rubber material similar to the one that is generally employed for offset printing is wound around the surface of the blanket cylinder 8.

Thus, only part of the thickness of the layer of the ink 21 fed onto the plate cylinder 60 is intermediately transferred onto the blanket cylinder 8 that is arranged with a desired gap between them. The quantity by which ink is transferred (the thickness of the layer of the ink 21) is controlled by an adjustment method of adjusting the “gap between the plate cylinder 60 and the blanket cylinder 8” and so on that is being generally employed for offset printing. Of course, it also is related to adjustment of the thickness of the ink 21 held to the surface of the plate cylinder 60 and hence “the gap between the ink roller 5 and the plate cylinder 60” and “the thickness of the layer of the ink 21 on the surface of the ink roller 5” may also sometimes need to be adjusted.

Thereafter, the region on the photosensitive drum 1 where the transfer step to the plate cylinder 60 has been completed moves to the position of the first cleaner 7. The first cleaner 7 is designed to operate for cleaning by way of a scraping off operation by means of a rubber blade. Thereafter, the region on the photosensitive drum 1 is moved to the position of the charge eliminator 6 to eliminate the electric charge.

Thereafter, the region on the plate cylinder 60 where the transfer step to the blanket cylinder 8 has been completed moves to the position of the third cleaner 61. The third cleaner 61 is designed so as to collectively remove the compression-bonded ink repellent particles 63 and the ink 21 by way of a scraping off operation by means of a rubber blade and subsequently wash the region. Whenever necessary, a heater may be arranged in the inside of the third cleaner 61 or around the third cleaner 61 to melt the compression-bonded ink repellent particles 63 and remove them by the third cleaner 61. If necessary, a drying unit may be arranged downstream relative to the site where the cleaning step by the third cleaner 61 is conducted.

The image formed by the ink 21 that is intermediately transferred onto the blanket cylinder 8 is then transferred onto the sheet of paper 11 that is a recording medium pinched between the blanket cylinder 8 and the impression cylinder 10 to complete the printing. The region on the blanket cylinder 8 where the step of transferring the image onto the sheet of paper 11 has been completed is cleaned by the second cleaner 9 so as to remove the residual ink and restore the initial state. Then, ondemand digital offset printing is realized after completing an operation by the charger 2 and a step of proceeding to the exposure unit 3 for another time.

While single color printing using black ink is described above for the sake of convenience, full color printing can be realized by providing the arrangement of FIG. 13 also for inks 21 of cyan, magenta and yellow.

Thus, the printing method of this embodiment is a printing method of employing a rewritable plate. The method includes a first step of drawing a latent image on the surface of the photosensitive drum 1 that operates as plate forming body for forming a rewritable plate and a second step of causing ink repellent particles 20 to adhere to the surface of the photosensitive drum 1 according to the latent image to form a protrusion. The method further includes a third step of transferring the ink repellent particles 20 adhering to the surface of the photosensitive drum 1 to the surface of the plate cylinder 60 that operates as the second plate forming body to form an image part. The method then includes a fourth step of heating the ink repellent particles 20 adhering to the surface of the plate cylinder 60 that operates as plate forming body to melt and thermo-compression-bonding them to the surface of the plate cylinder 60 by means of the thermo-compression-bonding unit 62. The method also includes a fifth step of feeding ink 21 to the surface of the plate cylinder 60 to form an image part and a sixth step of transferring the ink 21 on the surface of the plate cylinder 60 onto the blanket cylinder 8 that operates as intermediate transfer member. The method additionally includes a seventh step of transferring the ink 21 on the surface of the blanket cylinder 8 onto a sheet of paper 11 that is a recording medium. Furthermore, the surfaces of the compression-bonded ink repellent particles 63 are made to have a property of repelling ink 21 whereas the surface of the plate cylinder 60 is made to have a property of not repelling ink 21.

When same printed matters are to be output, high-speed printing can be realized by skipping the operations of the first cleaner 7, the charge eliminator 6, the charger 2, the exposure unit 3, the developing unit 4, the second cleaner 9, the thermo-compression-bonding unit 62 and the third cleaner 61 after executing a developing operation by means of the ink repellent particles 20.

### INDUSTRIAL APPLICABILITY

The present invention can find applications in ondemand offset printing apparatus and also ondemand offset printing methods.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-192706, filed Aug. 24, 2009 and Japanese Patent Application No. 2009-269187, filed Nov. 26, 2009 which are hereby incorporated by reference herein in their entirety.

### REFERENCE SIGNS LIST

1: photosensitive drum (plate forming body; amorphous silicon photosensitive body)

3: exposure unit (latent image forming unit)

4: developing unit (protrusion forming unit)

5: ink roller (ink feeding unit)

8: blanket cylinder (intermediate transfer member)

10: impression cylinder (pressing unit)

11: sheet of paper (recording medium)

20: ink repellent particles

21: ink

60: plate cylinder (second plate forming body)

62: thermo-compression-bonding unit (heating unit)

70: thermo-compression-bonding unit (heating unit)

1. A printing apparatus employing a rewritable plate, comprising:
a plate forming body for forming a rewritable plate;
a latent image forming unit for forming a latent image on a region of a surface of the plate forming body;
a protrusion forming unit for forming a protrusion by selectively causing ink repellent particles to adhere to the region of the surface of the plate forming body carrying a latent image formed thereon;
an ink feeding unit for feeding ink to the surface of the plate forming body;
an intermediate transfer member having a surface for receiving ink transferred from the surface of the plate forming body;
a pressing unit for pressing ink on the surface of the intermediate transfer member to transfer the ink onto a recording medium; and
a conveying unit for conveying a recording medium,
wherein the surface of the ink repellent particles have a property of repelling the ink, and the surface of the plate forming body has a property of not repelling the ink.

2. The apparatus according to claim 1, wherein the ink is oil-based ink and the surface of the ink repellent particles is oil repellent while the surface of the plate forming body is oil-philic.

3. The apparatus according to claim 1, wherein the ink is water-based ink and the surface of the ink repellent particles is water repellent while the surface of the plate forming body is hydrophilic.

4. The apparatus according to claim 1, wherein the plate forming body is an amorphous silicon photosensitive body.

5. The apparatus according to claim 1, further comprising a heating unit for heating ink repellent particles having selectively adhered to the region of the surface of the plate forming body where a latent image is formed.

6. A printing apparatus employing a rewritable plate, comprising:
a first plate forming body for forming a rewritable plate;
a latent image forming unit for forming a latent image on a region of a surface of the first plate forming body;
a protrusion forming unit for forming a protrusion by selectively causing ink repellent particles to adhere to the region of the surface of the first plate forming body carrying a latent image formed thereon;
a second plate forming body for holding on a surface thereof ink repellent particles transferred from the surface of the first plate forming body;
an ink feeding unit for feeding ink to the surface of the second plate forming body;
an intermediate transfer member having a surface for receiving ink transferred from the surface of the second plate forming body;
a pressing unit for pressing ink on the surface of the intermediate transfer member to transfer the ink onto a recording medium; and
a conveying unit for conveying a recording medium,
wherein the surface of the ink repellent particles have a property of repelling the ink, and the surfaces of the first and second plate forming bodies have a property of not repelling the ink.

7. The apparatus according to claim 6, wherein the ink is oil-based ink and the surface of the ink repellent particles is oil repellent while the surfaces of the first and second plate forming bodies are oil-philic.

8. The apparatus according to claim 6, wherein the first plate forming body is an amorphous silicon photosensitive body and the second plate forming body is made of aluminum.

9. The apparatus according to claim 6, further comprising a heating unit for heating ink repellent particles having selectively adhered to the region of the surface of the second plate forming body where a latent image is formed.

10. A printing method employing a rewritable plate, comprising:
a first step of forming a latent image on a surface of a plate forming body for forming a rewritable plate;
a second step of forming a protrusion on the surface of the plate forming body by causing ink repellent particles to adhere thereto according to the latent image;
a third step of feeding ink to the surface of the plate forming body to form an image part thereon with the ink;
a fourth step of transferring the ink on the surface of the plate forming body onto a surface of an intermediate transfer member; and
a fifth step of transferring the ink on the surface of the intermediate transfer member onto a recording medium,
wherein the surface of the ink repellent particles have a property of repelling the ink, and the surface of the plate forming body has a property of not repelling the ink.

11. The method according to claim 10, wherein the ink is oil-based ink and the surface of the ink repellent particles is oil repellent while the surface of the plate forming body is oil-philic.

12. The method according to claim 10, wherein the ink is water-based ink and the surface of the ink repellent particles is water repellent while the surface of the plate forming body is hydrophilic.

13. The method according to claim 10, wherein the plate forming body is an amorphous silicon photosensitive body.

14. The method according to claim 10, further comprising a step of thermo-compression-bonding the ink repellent particles having adhered to the surface of the plate forming body by means of a heating unit between the second step and the third step.

15. A printing method employing a rewritable plate and comprising:
a first step of forming a latent image on a surface of a first plate forming body for forming a rewritable plate;
a second step of forming a protrusion on the surface of the first plate forming body by causing ink repellent particles to adhere thereto according to the latent image;
a third step of transferring the ink repellent particles on the surface of the first plate forming body onto a surface of a second plate forming body;
a fourth step of feeding ink to the surface of the second plate forming body to form an image part thereon with the ink;
a fifth step of transferring the ink on the surface of the second plate forming body onto a surface of an intermediate transfer member; and
a sixth step of transferring the ink on the surface of the intermediate transfer member onto a recording medium,
wherein the surface of the ink repellent particles have a property of repelling the ink, and the surfaces of the first and second plate forming bodies have a property of not repelling the ink.

16. The method according to claim 15, wherein the ink is oil-based ink and the surface of the ink repellent particles is oil repellent while the surfaces of the first and second plate forming bodies are oil-philic.

17. The method according to claim 15, wherein the first plate forming body is an amorphous silicon photosensitive body and the second plate forming body is made of aluminum.

18. The method according to claim 15, further comprising a step of thermo-compression-bonding the ink repellent particles having adhered to the surface of the second plate forming body by means of a heating unit between the third step and the fourth step.

19. The apparatus according to claim 1, wherein the ink repellent particles have a weight average particle size of from 5 μm to 30 μm.

20. The apparatus according to claim 1, wherein the apparatus uses no damping water.
